(19) United States
(12) Patent Application Publication
(10) Pub. No.: US 2026/0307896 A1
(43) Pub. Date: Oct. 8, 2026

(54) MANAGEMENT DEVICE AND COMMODITY REPLENISHMENT SYSTEM

(71) Applicant: TELEXISTENCE INC., Tokyo (JP)

(72) Inventors: Wilson COLIN, Tokyo (JP); Genki SANO, Tokyo (JP)

(73) Assignee: TELEXISTENCE INC., Tokyo (JP)

(21) Appl. No.: 19/483,273

(22) PCT Filed: May 13, 2024
(86) PCT No.: PCT/JP2024/017681

§ 371 Date: Nov. 11, 2025

(30) Foreign Application Priority Data
May 17, 2023 (JP) 2023-081921
Apr. 25, 2024 (JP) 2024-071257

(51) Int. Cl. B65G 1/04; B25J 11/00; G06Q 10/087; G06V 10/74; G06V 20/50

(52) U.S. Cl. CPC B65G 1/04; B25J 11/008; G06Q 10/08724; B65G 2203/0216; B65G 2203/0241; B65G 2203/0258; B65G 2203/041; G06V 10/74; G06V 20/50

(57) ABSTRACT

[Problem] To make it possible to reduce the burden required for a store employee to perform operation of replenishing products to a stock shelf.

[Solution] According to one embodiment of the present disclosure, a management apparatus 300 which manages product replenishment by a product replenishment robot 100 is provided. The product replenishment robot 100 performs operation of holding a product placed on a stock shelf and moving the product to a product display shelf, and operation of holding the product placed on the product replenishment shelf and moving the product to the stock shelf. The management apparatus 300 includes a control unit 310 and a memory unit 320. The memory unit 320 stores sales data including the past sales quantity and the sales date and time of the product or a learned model generated by performing machine learning on a learning device using the sales data. The control unit 310 is configured to perform generating product replenishment information regarding the product to be replenished on the stock shelf, based on the sales data or the learned model. The product replenishment information includes placement layout information for placing the product to be replenished to the stock shelf, in each area on the product replenishment shelf.

### TECHNICAL FIELD

The present disclosure relates to a management apparatus and a product replenishment system.

### BACKGROUND

International Patent Publication WO 2023/022214 discloses a product transfer system including a product transfer apparatus for moving a product placed on a stock shelf to a product display shelf which is different from the stock shelf in a store such as a convenience store. The product transfer apparatus includes a holder unit for holding a product, an arm unit for moving the holder unit to a stock shelf and a product display shelf, a first image capture unit for capturing an image of the product display shelf, a second image capture unit for capturing an image of the stock shelf, and a control unit for controlling operation of the arm unit, the holder unit, and the first and second image capture units.

The control unit of the product transfer apparatus is configured to identify a replenishment target product as a product required to be replenished on the product display shelf, based on the product display shelf capture image data generated by image capturing of the product display shelf by the first image capture unit, and identify a position of a stock product corresponding to the replenishment target product in the stock shelf capture image data, based on stock shelf capture image data generated by image capturing of the stock shelf by the second image capture unit. Further, the control unit causes the holder unit to hold the replenishment target product based on the stock shelf capture image data, and after the holder unit holds the replenishment target product, moves the holder unit toward the product display shelf, to place the replenishment target product on the product display shelf at the product placement position, based on the product display shelf capture image data.

In this manner, the product transfer apparatus disclosed in International Patent Publication WO 2023/022214 carries out replenishment operation by moving the product from the stock shelf to the product display shelf.

### SUMMARY

In the system disclosed in International Patent Publication WO 2023/022214, it is possible to replenish the product on the stock shelf by moving the product from the stock shelf to the product display shelf. However, it is still required for a store employee to replenish the product to the stock shelf.

A plurality of product rows divided by partition plates are provided on each shelf plate of the stock shelf. Certain products are stocked in each of the product rows, and the system recognizes which products are stocked in each of the product rows on each shelf plate of the stock shelf. For example, a label containing the product name, etc., to be replenished in each product row is placed in front of each product row on each shelf plate of the stock shelf. A store employee repeatedly performs the replenishment operation of checking the label and placing the products to be replenished to the product row. As described above, the operation of searching for the product row which needs replenishment while replenishing products onto the stock shelf requires a significant amount of time and effort. Moreover, stock shelves for beverage products in convenience stores, etc., are located within a low-temperature controlled backyard. Therefore, the store employee working in such low-temperature work environment also experiences significant physical strain.

Moreover, while the store employee is performing operation of replenishing products on the stock shelf, for safety reasons, it is necessary to move the product transfer apparatus up to a position where the product transfer apparatus does not obstruct operation of the store employee and stop operation of the product transfer apparatus. Therefore, during this period, the product transfer apparatus cannot be placed in operation. For this reason, replenishment of products onto the stock shelf by the store employee is one factor which reduces the utilization rate of the product transfer system.

An object of the present disclosure is to provide means which makes it possible to reduce the burden required for a store employee to perform operation of replenishing products to a stock shelf.

According to an aspect of the present disclosure, a management apparatus is provided. The management apparatus manages a product replenishment robot configured to perform operation of holding a product placed on a stock shelf and moving the product to a product display shelf, and operation of holding a product placed on the product replenishment shelf and moving the product to the stock shelf. The management apparatus includes a control unit and a memory unit. The memory unit stores sales data including the past sales quantity and the sales date and time of the product or a learned model generated by performing machine learning on a learning device using the sales data. The control unit is configured to generate product replenishment information regarding the product to be replenished on the stock shelf based on the sales data or the learned model, and the product replenishment information includes placement layout information for placing the product to be replenished on the stock shelf, in each area on the product replenishment shelf.

Other features and advantages of the present disclosure can be understood from the following description and the accompanying drawings which are given in an illustrative and non-exhaustive manner.

The present disclosure provides means which makes it possible to reduce the burden required for a store employee to perform operation of replenishing a product to a stock shelf.

### BRIEF DESCRIPTION OF THE DRAWINGS

FIG. 1 is a view showing overall structure of a product replenishment system according to a first embodiment of the present disclosure;

FIG. 2 is a plan view schematically showing the layout of shelves in a store and a product replenishment robot placed in the store;

FIG. 3(a) is a view showing a product display shelf viewed from the front side, and FIG. 3(b) is a view showing the product display shelf viewed from the back side;

FIG. 4 is a schematic view illustrating functions of a stock shelf;

FIG. 5 is a side view schematically showing structure of the product replenishment robot;

FIG. 6 is a perspective view showing structure around a front end of an arm unit of the product replenishment robot;

FIG. 7 is a block diagram showing structure of the product replenishment robot;

FIG. 8 is an image of a product display shelf captured by a first camera (left side) of the product replenishment robot;

FIG. 9 is a flow chart showing operation of replenishing a product by the product replenishment robot;

FIG. 10 is a perspective view showing overall structure of a product image acquisition apparatus;

FIG. 11 is a view showing a series of operations of obtaining an image of the product by the product image acquisition apparatus;

FIG. 12 is a block diagram showing structure of the management apparatus;

FIG. 13 is a block diagram showing structure of a terminal device;

FIG. 14 is a flow chart illustrating an operation example of the product replenishment system;

FIG. 15 is a view showing an example of a display screen of product replenishment information displayed on a display operation unit of the terminal device;

FIG. 16 is a view showing a state where identification information of a product replenishment shelf captured by a camera of the terminal device is displayed on the display operation unit of the terminal device;

FIG. 17 is a view showing an example of a display screen of placement layout information displayed on the display operation unit of the terminal device;

FIG. 18 is a view showing an example of operation start requirement information displayed on the display operation unit of the terminal device;

FIG. 19 is a view showing an example of completion confirmation requirement information displayed on the display operation unit of the terminal device;

FIG. 20 is a view showing an example of an alert message displayed on the display operation unit of the terminal device;

FIG. 21 is a perspective view showing overall structure of the product replenishment shelf in a second embodiment of the present disclosure;

FIG. 22 is a block diagram showing a control unit provided in the product replenishment shelf shown in FIG. 21;

FIG. 23 is a flow chart illustrating an operation example of the product replenishment system of the second embodiment;

FIG. 24 is a view showing an example of product replenishment information displayed on the display operation unit of the terminal device;

FIG. 25 is a view showing an example of product placement position table information in the second embodiment;

FIG. 26 is a perspective view showing overall structure of a stock shelf in the third embodiment;

FIG. 27 is a flow chart illustrating an operation example of the product replenishment system in the third embodiment; and

FIG. 28 is a view showing an example of product placement position table information in the third embodiment.

### DETAILED DESCRIPTION

Hereinafter, embodiments of the present disclosure will be described with reference to the drawings.

### First Embodiment

### <Overall Structure of Product Replenishment System>

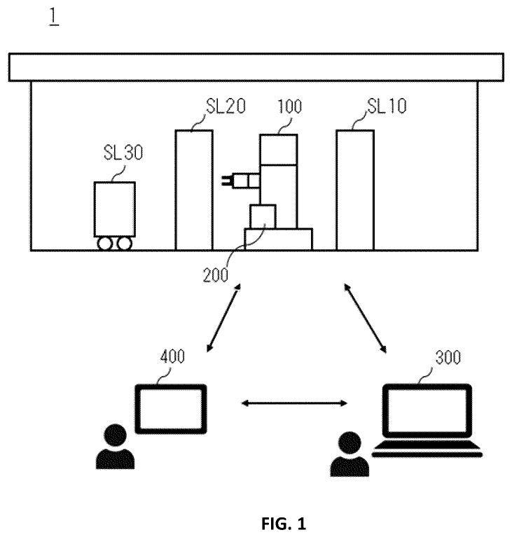

Firstly, the overall structure of the product replenishment system according to the first embodiment of the present disclosure will be described. FIG. 1 is a view showing overall structure of a product replenishment system according to a first embodiment of the present disclosure.

As shown in FIG. 1, the product replenishment system 1 according to the first embodiment of the present disclosure includes a product replenishment robot 100 for moving a product, a product image acquisition apparatus 200 provided on the product replenishment robot 100, a management apparatus 300 for performing management of schedules, etc. of product replenishment operation by the product replenishment robot 100, and a terminal device 400 operated by a store employee who is engaged in product replenishment, etc.

The product replenishment robot 100 is provided in a store such as a convenience store, and performs replenishment of products to a stock shelf SL20 and performs replenishment of products from the stock shelf SL20 to the product display shelf SL10. The product image acquisition apparatus 200 provided for the product replenishment robot 100 captures an image of a product placed on the product image acquisition apparatus 200. Based on the captured image of the product, the type of the product placed on the product image acquisition apparatus 200 is identified by a control device 150 of the product replenishment robot 100.

The management apparatus 300 transmits product replenishment information generated by scheduling the type and quantity, and the replenishment timing for the products to be replenished on the stock shelf SL20, to the terminal device 400. The product replenishment information includes placement layout information for placing various items of products on the product replenishment shelf SL30 for transporting the product to be replenished to the stock shelf SL20. Further, the management apparatus 300 causes the product replenishment robot 100 to perform operation of replenishing the product from the product replenishment shelf SL30 to the stock shelf SL20 based on the product replenishment schedule.

The terminal device 400 displays the product replenishment information transmitted from the management apparatus 300, on the display screen of the terminal device 400, and presents timing of replenishing the product to the stock shelf SL20 and the product replenishment information such as the type and the quantity of the product to be replenished on the stock shelf SL20, to the store employee who uses the terminal device. The store employee places each of the designated products in the designated quantity at a predetermined position on the product replenishment shelf SL30, in accordance with the placement layout information displayed on the screen of the terminal device 400.

The store employee moves the product replenishment shelf SL30 on which the replenishment product is placed to a position accessible by the product replenishment robot 100 at the timing indicated by the product replenishment information. The product replenishment robot 100 moves the products on the product replenishment shelf SL30 to predetermined positions on the stock shelf SL20, respectively, to replenish the products on the stock shelf SL20. At this time, as necessary, the product replenishment robot 100 may place the products on the product image acquisition apparatus 200, and identify the type of the products to be replenished. During replenishment operation of the products onto the stock shelf SL20, or after completion of the replenishment operation of the products onto the stock shelf SL20, the product replenishment robot 100 moves the products from the stock shelf SL20 to the product display shelf SL10 to replenish the products on the product display shelf.

As described above, the product replenishment system 1 according to the present disclosure replenishes the products from the product replenishment shelf SL30 to the stock shelf SL20 in accordance with product replenishment information indicating the type and the quantity of the product to be replenished to the stock shelf SL20 and the replenishment timing, and replenishes the products from the stock shelf SL20 to the product display shelf SL10.

### <Layout Configuration in the Store>

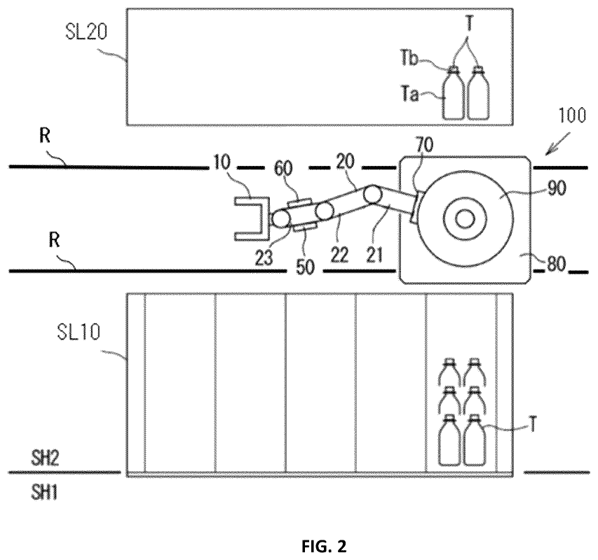

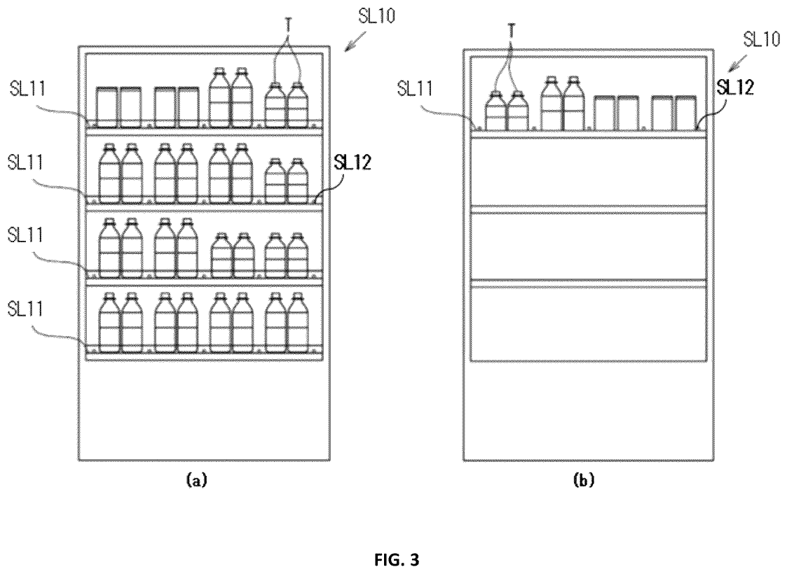

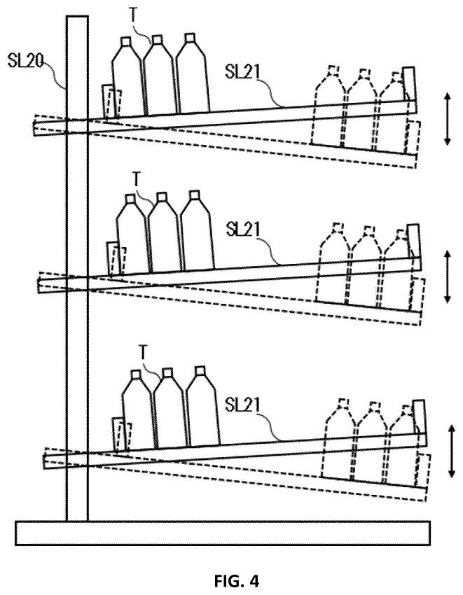

Next, layout configuration in the store will be described. FIG. 2 is a plan view schematically showing the layout of shelves in a store and a product replenishment robot placed in the store. FIG. 3(a) is a view showing a product display shelf viewed from the front side, and FIG. 3(b) is a view showing the product display shelf viewed from the back side. FIG. 4 is a schematic view illustrating functions of a stock shelf.

As shown in FIG. 2, the store has an in-store space (SH1) and a backyard space (SH2). The in-store space SH1 is a space where customers select and purchase products T. The backyard space SH2 is a space where stocks of the products T are stored. In the store, the product display shelf SL10, a stock shelf SL20, a product replenishment shelf SL30, the product replenishment robot 100, and the product image acquisition apparatus 200 on the product replenishment robot 100 are provided. A track made up of two rails R is laid on the floor between the product display shelf SL10 and the stock shelf SL20 in the store. The product replenishment robot 100 is configured to move on these rails R toward left and right shown in the drawing.

For example, the product T is a beverage container having a main body portion Ta and a cap portion Tb provided at an upper end of the main body portion Ta, or a cylindrical beverage can container. The product T may be formed of various materials such as PET, glass, aluminum, steel, or other metals.

As shown in FIG. 3(a) and 3(b), the product display shelf SL10 has a plurality of shelf plates SL11 (also referred to as the levels of the product display shelf). A plurality of types of products T are placed on the shelf plate SL11. For example, the products T of the same type are arranged in two rows or three rows. The products T may be arranged in only one row. A plurality of partition plates SL12 dividing the products T arranged in each row are provided on the upper surface of each of the shelf plates SL11. In FIG. 3, an example of products T of the same type arranged in two rows is illustrated, and in this example, a partition plate SL12 is provided for every two rows of products T. The layout of the partition plate SL12 is not limited to the above example, and the partition plate SL12 can be arranged at intervals of one row or two or more rows.

The front side of the product display shelf SL10 faces the in-store space SH1. So, customers can take products T from the front side of the product display shelf SL10. The shelf plate SL11 is inclined such that the front side gets lower relative to the back side. In the structure, when a customer takes a product T, other products T arranged behind the product T slide on the shelf plate SL11, and move toward the front side.

The back side of the product display shelf SL10 faces the backyard space SH2. So, the store employee or the product replenishment robot 100 can replenish the product display shelf SL10 with the products T from the back side of the product display shelf SL10. Although not shown in the drawings, doors may be provided on the front and back sides of the product display shelf SL10. In FIG. 3, though only one product display shelf SL10 is drawn for simplicity of illustration, a plurality of product display shelves SL10 may be provided in the store.

In the backyard space SH2, the stock shelf SL20 is provided to face the product display shelf SL10, and the front surface of the stock shelf SL20 and the back surface of the product display shelf SL10 face each other. As in the case of the product display shelf SL10, the stock shelf SL20 includes a plurality of shelf plates (levels) disposed in the height direction. Replenish target products which are target products to be replenished on the product display shelf SL10 are arranged on the shelf plates of the stock shelf SL20. A store employee or the product replenishment robot 100 replenishes the products T to the stock shelf SL20, from the front side of the stock shelf SL20.

The product replenishment shelf SL30 includes a plurality of shelf plates (levels) arranged in the height direction. A plurality of casters are provided at the bottom of the product replenishment shelf SL30 for causing the product replenishment shelf SL30 to move in an arbitrary direction. Further, a label containing characters, two-dimensional codes, etc. as identification information for identifying the product replenishment shelf SL30 may be attached to the product replenishment shelf SL30. The identification information contained in the label can be read using a camera provided for the terminal device 400.

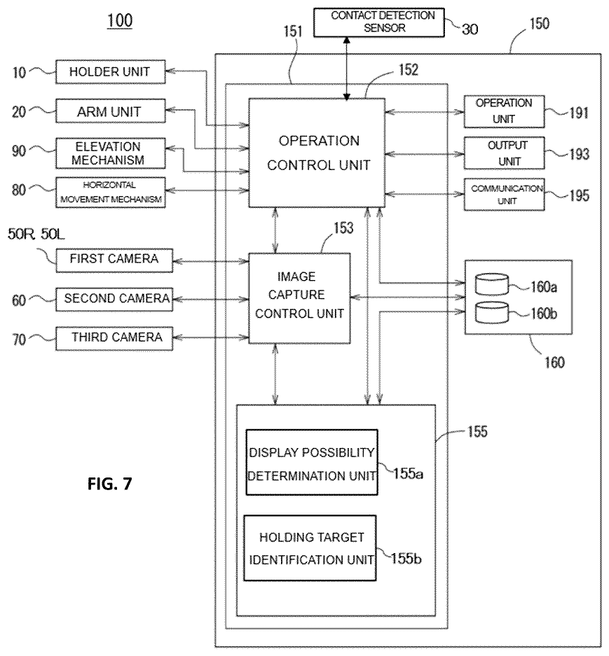

Next, structure and functions of the stock shelf SL20 in the present embodiment will be described with reference to FIG. 4. Each of the shelf plates SL21 of stock shelf SL20 is configured to be switchable between a first posture where the end on the front side (right side in the drawing) is higher than the end on the back side (left side in the drawing) as shown by solid lines in FIG. 4 and a second posture where the end on the front side is lower than the end on the back side, as shown by dotted lines in FIG. 4. The stock shelf SL20 includes a drive mechanism (not shown) for switching each of the shelf plates SL21 between the first posture and the second posture. For example, the drive mechanism includes an electric motor as a drive source. The drive mechanism switches the posture of each of the shelf plates SL21 between the first posture and the second posture, in response to a control signal transmitted from a communication unit 195 (see FIG. 7) of the product replenishment robot 100. A plurality of drive mechanisms may be provided individually for respective shelf plates SL21 to drive the respective shelf plates SL21 of the stock shelf SL20 individually. Alternatively, a single drive mechanism may be provided to drive the plurality of shelf plates SL21 together through a coupling mechanism, etc.

At the time of replenishing the products on each of the shelf plates SL21 of the stock shelf SL20 by the product replenishment robot 100, the shelf plate SL21 is placed in the first posture where the end on the front side of the shelf plate SL21 is higher than the end on the back side of the shelf plate SL21. In the first posture, the shelf plate SL21 is inclined downward from the front side to the back side. In the structure, the product placed on the front side of a predetermined product row on the shelf plate SL21 for replenishment moves to slide down toward the back side of the shelf plate SL21 along the downward slope from the front side to the back side. Therefore, by repeating operation of placing the products on the front side on the shelf plate SL21, it is possible to successively replenish the products in the product row of the shelf plate SL21.

On the other hand, at the time of replenishing the products on the product display shelf SL10 by moving the products on the stock shelf SL20 to the product display shelf SL10 by the product replenishment robot 100, the shelf plate SL21 is placed in the second posture where the end on the front side of the shelf plate SL21 is lower than the end on the back side of the shelf plate SL21. In the second posture, the shelf plate SL21 is inclined downward from the back side to the front side. Therefore, the product placed in each product row of the shelf plate SL21 moves to slide down toward the front side of the shelf plate SL21, along the slope inclined downward from the back side to the front side. Each time the product located at the foremost position on the front side of stock shelf SL20 is taken out of the stock shelf SL20 by product replenishment robot 100 for replenishment, the products located behind the removed product sequentially move to slide down toward the front side of the shelf plate SL21. Therefore, it becomes possible for the product replenishment robot 100 to take out the product located at the foremost position on the front side of the stock shelf SL20, and move the product to the product display shelf SL10 for replenishment.

### <Structure and Operation of the Product Replenishment Robot 100>

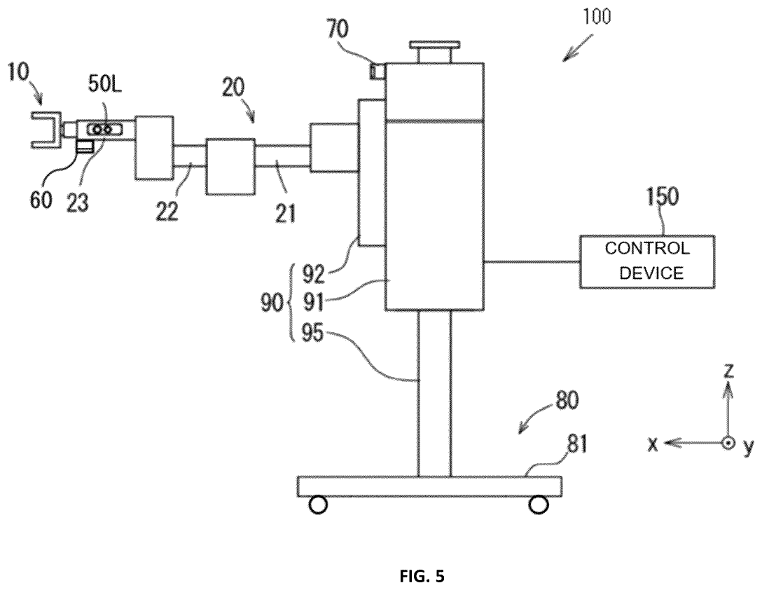

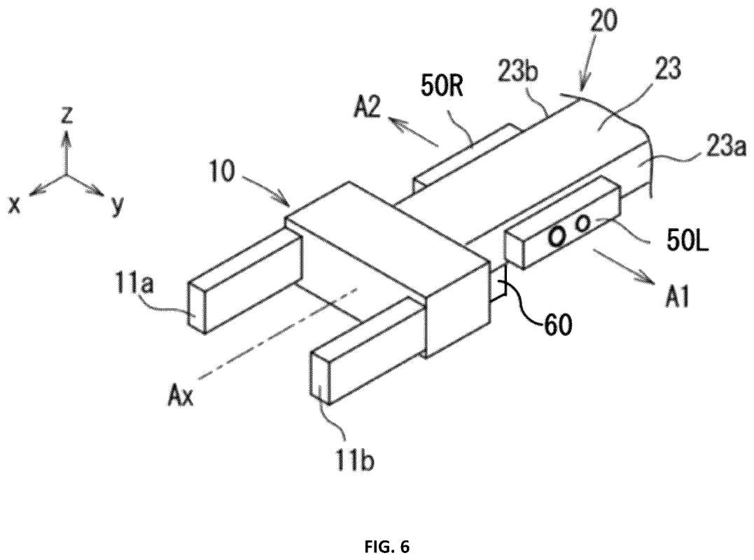

The product replenishment robot 100 will be described below with reference to FIG. 2 and FIGS. 5 to 7. FIG. 5 is a side view schematically showing structure of the product replenishment robot 100. FIG. 6 is a perspective view showing structure around a front end of an arm unit of the product replenishment robot 100. FIG. 7 is a block diagram showing structure of the product replenishment robot 100.

The product replenishment robot 100 includes a holder unit 10, an arm unit 20, a contact detection sensor 30, first cameras 50R, 50L, a second camera 60, a third camera 70, a horizontal movement mechanism 80, an elevation mechanism 90, and the control device 150. The product replenishment robot 100 is a robot which moves in a space between the product display shelf SL10 and the stock shelf SL20. The product replenishment robot 100 performs operation of holding the product T on the product replenishment shelf SL30 by the holder unit 10 and moving the product T to the stock position of the stock shelf SL20 where the product T should be stored (lane which stores the product T) and operation of holding the product T in the stock shelf SL20 and moving the held product T to the display position of the product display shelf SL10 where the product T should be displayed (lane which displays the product T).

As shown in FIG. 6, the holder unit 10 includes a pair of fingers 11a, 11b for holding a target object. The pair of fingers 11a, 11b have a shape configured to hold the product T such as a PET bottle beverage at a position near the cap portion Tb of the container. Further, the pair of fingers 11a, 11b have a shape configured to hold an outer peripheral portion of a canned beverage as the product T. The holder unit 10 may not necessarily be in the form of the pair of fingers 11a, 11b. Alternatively, the holder unit 10 may be configured to hold a target object by adsorption or may be configured to hold a target object by using an adhesive force, a magnetic force, etc. Preferably, a flexible holder member (not shown) is provided on the holding surface of each of the fingers 11a, 11b so that the product T can be held more suitably when the product T is gripped. For example, the holder member may be formed of rubber sheet material, urethane resin sheet material, etc.

The arm unit 20 includes a plurality of link members 21, 22, 23. The plurality of link members 21, 22, 23 form a multi-joint robot arm. For example, the multi-joint robot arm may be a 6-axis arm with degrees of freedom in a straight direction along each of the X, Y, and Z axis directions, and with degrees of freedom in each of the directions about the X, Y, and Z axes. The multi-joint robot arm may have any other mechanism, such as an orthogonal coordinate system robot arm, a polar coordinate system robot arm, a cylindrical coordinate system robot arm, or a SCARA robot arm. One end of the arm unit 20 is fixed to the elevation mechanism 90. The holder unit 10 is provided at a front end of the arm unit 20. Operation of the arm unit 20 is controlled by the control device 150.

The arm unit 20 can move the holder unit 10 toward the stock shelf SL20 or toward the product display shelf SL10 by moving respective link members 21, 22, 23. The orientation of the arm unit 20 is not fixed to a certain direction. However, for the sake of explanation, the direction in which the respective link members 21, 22, 23 are extended will be referred to as the extension direction Ax of the arm unit 20 (see FIG. 6). The arm unit 20 moves the holder unit 10 forward toward the product T to hold the product T. The extension direction Ax of the arm unit 20 corresponds to the forward direction of the holder unit 10 in the holding operation.

The contact detection sensor 30 is a sensor which detects contact of the holder unit 10 with the product T when the holder unit 10 holds the product T, and detects contact of the product T held by the holder unit 10, the holder unit 10 or the arm unit 20 with an obstacle such as a wall or a pillar of the product display shelf SL10 or the stock shelf SL20 when the product T held by the holder unit 10 is placed on the shelf plate SL21 of the stock shelf SL20 or the shelf plate SL11 of the product display shelf SL10. For example, a torque sensor, an acceleration sensor, an inertial measurement unit (IMU), a motor input current sensor, etc. can be used as the contact detection sensor 30.

For example, a strain gauge can be used as a torque sensor to detect the torque generated in the shaft of each joint of the arm unit 20. Various types of acceleration sensors, such as capacitance type or piezoresistive type, mounted on the holder unit 10 or the arm unit 20 can be used as the acceleration sensors.

The inertial measurement unit (IMU) is a device which detects three-dimensional inertial motion (translational and rotational motion in three orthogonal axes), and the inertial measurement unit (IMU) is equipped with an acceleration sensor to detect translational motion and an angular velocity (gyro) sensor to detect rotational motion. Among these sensors, the gyro sensor can be used to detect angular velocity to obtain the angle or angular change of the target object. For example, in the case where gears or gears and toothed belts are used as drive transmission means for the wrist portion of the holder unit 10, the motion of the wrist portion of the holder unit 10 can have redundancy due to play between gears or stretching of the toothed belt. So, for example, during the operation of placing the product T held by the holder unit 10 on the shelf plate SL11 of the product display shelf SL10 or the shelf plate SL21 of the stock shelf SL20, in the state where the product T is in contact with the shelf plate SL11 or the shelf plate SL21, if an additional force is applied to the holder unit 10 by moving the arm unit 20 further, as a result, some displacement will be caused in the wrist portion of the holder unit 10, and the posture (i.e., angle) of the holder unit 10 changes. Therefore, such angular changes which may occur in the holder unit 10 during the operation of placing the product T on the shelf plate SL11 or the shelf plate SL21 can be detected by the IMU mounted on the holder unit 10 to detect that the product T has come into contact with the shelf plate SL11 or the shelf plate SL21.

Further, in the present embodiment, the inertial measurement unit (IMU) is used as the contact detection sensor 30. Therefore, in a series of operations in the case of holding the cap portion Tb of the PET bottle beverage as the product T, by the holder unit 10, it becomes possible to detect the relative height positions between the PET bottle beverage as a holding target and the holder unit 10, by detecting the pitch angle of the holder unit 10 when the holder unit 10 is lowered and brought into contact with the vicinity of the neck of the PET bottle beverage. Further, by adjusting the height of the holder unit 10 from the state where the holder unit 10 is in contact with the vicinity of the neck of the PET bottle beverage, it becomes possible for the holder unit 10 to hold the cap portion Tb of the PET bottle beverage at a suitable height position.

In the case where a servomotor or the like is used to drive each joint of the arm unit 20, when an external force which causes an angle deviation from the angle at which the holding posture is maintained occurs, the servomotor operates to keep the angle deviation at zero in order to maintain the original angle. In the state where the product T held by the holder unit 10 is in contact with the shelf plate SL11 of the product display shelf SL10 or the shelf plate of the stock shelf SL20, at the time of moving the arm unit 20 further, electric current is input to the servomotor to drive the servomotor in opposition to the load. Therefore, by detecting the electric current inputted to the servomotor for such operation using the motor input current sensor, it is possible to detect that the product T is in contact with the shelf plate SL11 or the shelf plate SL21. For example, the motor input current sensor may be in the form of a control unit 151 (see FIG. 7) described later.

Two first cameras 50R, 50L are provided on both of the left and right sides of the arm unit 20, respectively. The first camera 50L mounted on the first side surface 23a which is the left side of the arm unit 20 is oriented in a first orientation A1 along a direction perpendicular to the extension direction Ax of the arm unit 20 (see FIG. 6). The first camera 50L is mainly used for capturing an image of the product display shelf SL10. The first camera 50R mounted on a second side surface 23b which is the right side of the arm unit 20 in parallel to the first side surface 23a and opposite to the first side surface 23a is oriented in a second orientation A2 which is opposite to the first orientation A1. The first camera 50R is mainly used for capturing an image of the stock shelf SL20. As described above, the first cameras 50R, 50L are disposed in opposite directions to each other. Therefore, while keeping the arm unit 20 in the same posture, it is possible to capture images of the product display shelf SL10 and the stock shelf SL20 by the first cameras 50R, 50L, respectively, at the same time.

The performance of the first camera 50R and the performance of the first camera 50L may be the same, or may be different. Hereinafter, for the purpose of brevity of description, an example where both of the cameras have the same performance will be described. It should be noted that the purpose and/or the condition of capturing the image of the product display shelf SL10 and the purpose and/or the condition of capturing the image of the stock shelf SL20 are different. Therefore, it is a matter of course that cameras having different performances may be used depending on the respective purposes and conditions.

For example, the first cameras 50R, 50L may have an image capture element and a depth sensor. The image capture element generates a capture image (RGB image in one example) in which pixels are arranged in two dimensions. The depth sensor is a distance detection device for generating distance data. The depth sensor is not limited to a certain type as long as the depth sensor is capable of obtaining data of the distance to the target object. For example, the depth sensor may use a stereo lens system or a LiDAR (Light Detection and Ranging) system. For example, the depth sensor may generate Depth images. In other embodiments of the present invention, either or both of the first cameras 50R, 50L may, for example, utilize an ultrasonic element to obtain the distance data.

It should be noted that the first camera 50L is oriented in the first orientation A1. This means that the image capture direction of the image capture element and the depth sensor of the first camera 50L is the orientation A1. Likewise, the first camera 50R is oriented in the second orientation A2. This means that the image capture direction of the image capture element and the depth sensor of the first camera 50R is in the orientation A2. The orientations A1 and A2 do not necessarily have to be 180° opposites to each other, as long as the orientations A1 and A2 allow image capturing of the product display shelf SL10 and the stock shelf SL20.

One or both of the first cameras 50R, 50L may be provided on the holder unit 10. The first cameras 50R, 50L may not necessarily be provided on the same member. For example, the first camera 50R may be mounted on one of the link members 21 to 23, and the first camera 50L may be mounted on another one of the link members 21 to 23. However, in the case where the first cameras 50R, 50L are provided on the same member, in comparison with the case where the cameras 50R, 50L are provided on separate link members, respectively, there is an advantage that image processing computation is simplified because a common coordinate system is used.

The second camera 60 is used to capture an image showing the state where the holder unit 10 holds the product T, and the positional relationship between the product T held by the holder unit 10 and the shelf plate SL11 of the product display shelf SL10 or the shelf plate SL21 of the stock shelf SL20. As in the case of the first cameras 50R, 50L, the second camera 60 may have an image capture element and a depth sensor. The image capture element generates a capture image (RGB image in one example) in which pixels are arranged in two dimensions. The depth sensor generates distance data.

For example, the second camera 60 may be provided below the link member 23 closest to the holder unit 10, among the link members 21 to 23 of the arm unit 20, at a position close to the holder unit 10. The image capture direction of the imaging element and the depth sensor of the second camera 60 is oriented directly downward (in the −z direction in FIGS. 5 and 6) or downward forward (somewhat more +x direction than in the −z direction in FIGS. 5 and 6) of the link member 23 and the holder unit 10. In the structure, the second camera 60 can capture at least a lower portion of the product T held by the holder unit 10 and the shelf plate SL11 or the shelf plate SL21 positioned on the front side of the holder unit 10.

The third camera 70 is a camera for capturing an image of a predetermined target object by changing the orientation, e.g., in accordance with operation of an operator at a remote location. For example, the third camera 70 is mounted on part of the elevation mechanism 90. The third camera 70 is capable of moving horizontally and vertically in a space between the product display shelf SL10 and the stock shelf SL20, in accordance with operation of the horizontal movement mechanism 80 and the elevation mechanism 90. Further, the portion of the elevation mechanism 90 on which the third camera 70 is mounted is rotatable about a pillar 95, and the third camera 70 is configured to rotate and move left and right about the pillar 95 as the portion rotates, and capture the image of the product display shelf SL10 and capture the image of the stock shelf SL20 as necessary.

For example, the third camera 70 may adopt a stereo lens system. Although not limited, the third camera 70 may have a wide angle of view in comparison with the first cameras 50L, 50R and the second camera 60.

The horizontal movement mechanism 80 has a base plate 81 and a drive mechanism (not shown). The base plate 81 supports the elevation mechanism 90, and slides along a rail (not shown) provided between the product display shelf SL10 and the stock shelf SL20 in the store. The drive mechanism (not shown) includes a motor, a roller, etc., and operates based on a control signal from the control device 150 (see FIG. 7) to move the elevation mechanism 90 to a predetermined position along the rail. The elevation mechanism 90 has the pillar 95, a first elevation mechanism 91, and a second elevation mechanism 92. The pillar 95 is fixed on the base plate 81 and extends in the vertical direction.

The first elevation mechanism 91 has a drive mechanism (not shown). The drive mechanism (not shown) includes a motor and a linear guide, and operates based on a control signal from the control device 150 (see FIG. 7). By operating the drive mechanism (not shown), the first elevation mechanism 91 moves vertically up and down along the pillar 95. The upper portion of the first elevation mechanism 91, to which the third camera 70 is attached, is configured to be driven to rotate in the left-right direction about the pillar 95.

The second elevation mechanism 92 is held by the first elevation mechanism 91. One end of the arm unit 20 is attached to the second elevation mechanism 92. The second elevation mechanism 92 has a drive mechanism (not shown). The drive mechanism (not shown) includes a motor, a linear guide, etc., and operates based on a control signal from the control device 150 (see FIG. 7). By operating the drive mechanism (not shown), the second elevation mechanism 92 also moves vertically up and down.

In the case of holding a product T which is present at a predetermined height, the elevation mechanism 90 moves the arm unit 20 and the holder unit 10 by the first elevation mechanism 91 to a height around which the product T can be held, and finely adjusts the height of the arm unit 20 and the holder unit 10 by the second elevation mechanism 92.

In the present embodiment, the first elevation mechanism 91 and the second elevation mechanism 92 are provided as elevation mechanisms. However, in other embodiments of the present invention, only one elevation mechanism may be provided.

### <Structure of the Control Device 150>

As shown in FIG. 7, the control device 150 has the control unit 151, a memory unit 160, an input unit 191, an output unit 193, and a communication unit 195. In FIG. 7, though the control device 150 is drawn as a single element, the control device 150 does not necessarily have to be a physically single element, but may be composed of a plurality of elements that are physically separated from each other.

The input unit 191 is a device for receiving input from the operator. The input unit 191 may be made up of devices such as a keyboard, a mouse, a touch panel, etc. for providing input to a computer. The input unit 191 may have an audio input device such as a microphone. Further, the input unit 191 may have a gesture input device which recognizes and identifies operator's movements through image recognition.

The output unit 193 is used for causing the product replenishment robot 100 to output an alert to a store employee, etc. For example, the output unit 193 is made up of one of, or a combination of devices such as a speaker, a display, a light-emitting device, and a vibration device. The communication unit 195 has a function of receiving data from the outside and transmitting data to the outside. In the case where the product replenishment robot 100 is configured to be operated remotely, an input from the operator through an operation unit of an external device (not shown) is received by the communication unit 195, and the control device 150 causes the product replenishment robot 100 to perform a predetermined operation based on the input. It should be noted that communication between the operation unit of the external device and the communication unit 195 may be either wired communication or wireless communication.

In the case where the product replenishment robot 100 is configured to be operated remotely, the operation unit 191 may be a device worn by the operator. The device includes a display device (not shown) and an operation device (not shown). The display device has a display which is visible to the operator. For example, the display device may be a head mount display (HMD). For example, the operation device may include one or more input sensors which can detect movement of the operator's body parts (e.g., hands and arms).

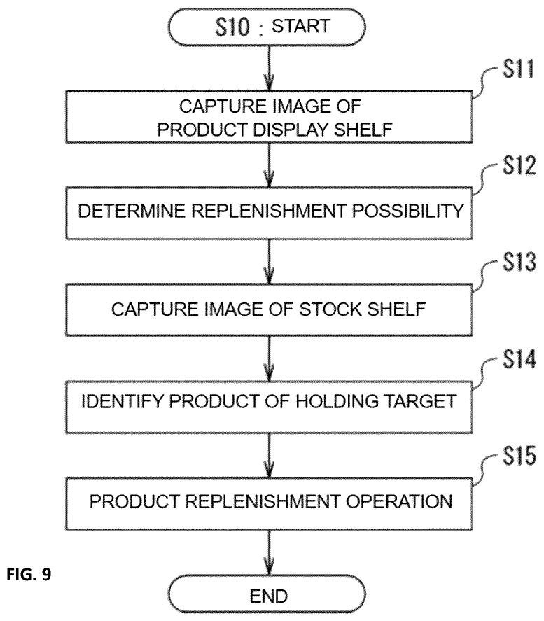

The memory unit 160 includes a transitory or non-transitory storage medium such as a ROM (Read Only Memory), a RAM (Random Access Memory) and an HDD (Hard Disk Drive). The memory unit 160 stores computer programs executed by the control unit 151, and/or learned models, etc., which will be described later. The computer programs stored in the memory unit 160 include an instruction for performing a method of controlling the product replenishment robot 100 by the control unit 151, which will be described later with reference to FIG. 9, etc.

The memory unit 160 includes an acquisition data memory unit 160a and a reference data memory unit 160b. The acquisition data memory unit 160a stores capture image data, etc. captured by each of the cameras 50R, 50L, 60, 70. The reference data memory unit 160b stores various items of data necessary for operation of the product replenishment robot 100. The various items of data include data regarding each of the shelves SL10 to SL30 (various items of shape data, position data, or lane coordinate data, etc.), and data regarding the product T (shape data, position data, peripheral (or circumferential) image data, etc.).

The control unit 151 is made up of one, or two or more CPUs (Central Processing Unit). The control unit 151 functions as an operation control unit 152, an image capture control unit 153, and an image data processing unit 155 by executing a computer program stored in the memory unit 160.

The operation control unit 152 generates control signals for operating each of the holder unit 10, the arm unit 20, the horizontal movement mechanism 80, the elevation mechanism 90, and the control device 150. The operation control unit 152 generates the control signals with reference to input signals from the operation unit 191 and/or various items of data stored in the memory unit 160. Generation of the control signal may be performed by using the processing results of the image data processing unit 155. The operation control unit 152 transmits/receives data via the communication unit 195, and generates a predetermined output through the output unit 193.

The image capture control unit 153 controls operation of each of the cameras 50R, 50L, 60, 70. The image capture timing, etc. of each of the cameras 50R, 50L, 60, 70 may be determined using data stored in the reference data memory unit 160b in advance.

The image data processing unit 155 performs various information processes using capture image data and the distance data (depth data) captured by each of the cameras 50R, 50L, 60, 70. For example, the image data processing unit 155 analyzes an image of image data captured by the first camera 50R, and identifies the products arranged on the stock shelf SL20 and the product replenishment shelf SL30. The image data processing unit 155 has a replenishment possibility determination unit 155a and a holding target identification unit 155b. Further, the image data processing unit 155 performs various information processes using the capture image data captured by a product image acquisition unit 260 of the product image acquisition apparatus 200 described later. For example, the image data processing unit 155 uses the peripheral (or circumferential) image data around the product captured by the image acquisition unit 260 (image including a product label, a barcode, etc. around the product), and performs a process of identifying the type of the product.

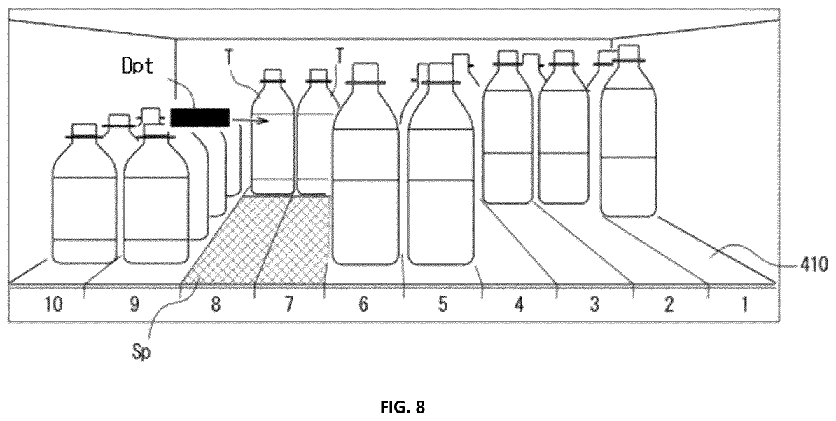

Based on at least one of the capture image data and the distance data generated by image capturing of the first camera 50L, the replenishment possibility determination unit 155a determines, for example, whether or not a space Sp (see FIG. 8) is present to place more products behind the rearmost product T arranged on the product display shelf SL10 and the stock shelf SL20. FIG. 8 shows an image of the product display shelf SL10 captured by the first camera 50L of the product replenishment robot 100. If a space Sp is present, it means that the product T needs to be replenished. Therefore, if the space Sp is present, the replenishment possibility determination unit 155a transmits a notification indicating that the product T should be replenished on the shelf plate SL11 below the space Sp, to the operation control unit 151. In the case where the operation control unit 151 receives this notification, the operation control unit 151 performs replenishment operation for the product T.

The holding target identification unit 155b performs at least one process among determination of whether or not a replenishment target product that is a holding target is present in the stock shelf SL20 and the product replenishment shelf SL30, identification of the size or shape of the replenishment target product, and determination of a holding position of the replenishment target product, based on at least one of the captured image data and the distance data captured by the first camera 50R. In the case where the product T has the cap portion Tb as shown in FIG. 2, for example, the holding target identification unit 155b sets a position near the cap portion Tb as the holding position. On the other hand, in the case where the product T is a canned beverage, etc. which does not have the cap portion, the holding target identification unit 155b may set a side portion of the container as the holding position.

### (Product Replenishment Operation by the Product Replenishment Robot 100)

Next, product replenishment operation by the product replenishment robot 100 will be described. Hereinafter, an example of replenishing the product T of the stock shelf SL20 to the product display shelf SL10 will be described. FIG. 9 is a flow chart showing replenishment operation of the product T by the product replenishment robot 100.

Firstly, in step S11, an image of the back side of the product display shelf SL10 is captured by the first camera 50L provided for the arm unit 20 of the product replenishment robot 100. The product replenishment robot 100 moves the arm unit 20, the horizontal movement mechanism 80, and the elevation mechanism 90 in a manner that an image of each level of the product display shelf SL10 can be captured by the first camera 50L. Next, the product replenishment robot 100 operates the first camera 50L to obtain the image of the back side of the product display shelf SL10, and obtains data of the distance to the product T (distance data) arranged on the product display shelf SL10.

Next, in step S12, replenishment possibility determination is made. The “replenishment possibility determination” is a step performed by the replenishment possibility determination unit 155a in the image data processing unit 155 of the product replenishment robot 100 to determine which products T can be displayed (in other words, which products T need to be replenished) on which shelf plate SL11 by analyzing the captured image of the back side of the product display shelf. The product replenishment robot 100 obtains the image of the back side of the product display shelf SL10 as shown in FIG. 6.

The image data processing unit 155 of the product replenishment robot 100 identifies the lane at the display destination of the shelf plate SL11 of the product display shelf SL10 using the capture image data captured by the first camera 50L. Further, since the image data processing unit 155 of the product replenishment robot 100 can obtain data of the distance to the product T (depth data Dep visually shown in FIG. 8), it is possible to recognize the presence of a space Sp behind the product T for items such as the products T in lanes “7” and “8”, where the number of displayed products has been decreased. The replenishment possibility determination unit 155a of the product replenishment robot 100 determines whether or not there is the space Sp for the product T based on the data of the distance to the product T, and whether or not more products T can be displayed in the lanes “7” and “8”. By the process of step S12, it is determined which products T need to be replenished on which shelf plate SL11 of the product display shelf SL10.

It should be noted that the method of determining whether or not products need to be replenished is not limited to the method described above, and various methods can be used. For example, it may be possible to determine what percentage of a given three-dimensional space is occupied by the products T and determine that the products T need to be replenished if the value is less than a predetermined reference value.

Next, in step S13, the image of the stock shelf SL20 is captured. The product replenishment robot 100 operates the arm unit 20, the horizontal movement mechanism 80, the elevation mechanism 90, and the first camera 50R to capture the image of the stock shelf SL20 from the front side. For example, the product replenishment robot 100 captures an image of the stock shelf SL20 one level at a time, and obtains the capture image indicating the stock condition of the product T. It is not essential to perform image capturing of the stock shelf SL20 after the image of the product display shelf SL10 is captured, and image capturing of the stock shelf SL20 may be performed before the image of the product display shelf SL10 is captured.

Next, in step S14, the image data processing unit 155 of the product replenishment robot 100 analyzes the capture image of the stock shelf SL20 obtained in step S13 to identify the products arranged on the stock shelf SL20. Further, the holding target identification unit 155b of the image data processing unit 155 identifies the holding position of the product. By the processes up to this point, information indicating which products T at which positions of which shelf plate SL11 of the product display shelf SL10 need to be replenished, information indicating the positions of the replenishment target products on the stock shelf SL20 corresponding to the products T, and the holding positions of the replenishment target products are obtained by the product replenishment robot 100.

Next, in step S15, the product replenishment robot 100 performs product replenishment operation (pick-and-place operation) based on the above obtained information. Specifically, the operation control unit 152 of the control unit 151 of the product replenishment robot 100 (see FIG. 7) operates the arm unit 20, the horizontal movement mechanism 80, and the elevation mechanism 90 to move the holder unit 10 toward a predetermined replenishment target product on the stock shelf SL20. Then, the holder unit 10 holds the previously identified holding position of the replenishment target product (in the case where the product T is a PET bottle beverage, the cap portion Tb of the PET bottle beverage), and lifts the replenishment target product. After that, the operation control unit 152 operates the arm unit 20, the horizontal movement mechanism 80, and the elevation mechanism 90 to move the held product T to a predetermined placement position on the product display shelf SL10, and releases the product T from the holder unit 10 to place the product T at the predetermined position. Thereafter, the product replenishment robot 100 repeats the pick-and-place operation in the same manner to complete replenishment of the products T.

While the example of replenishing the product T of the stock shelf SL20 to the product display shelf SL10 has been described, replenishment operation in the case of replenishing the product T of the product replenishment shelf SL30 to the stock shelf SL20 is performed according to the similar processes as described above. In this case, for example, an image of the front side of the stock shelf SL20 is captured by the first camera 50L, and the image processing unit 155 of the product replenishment robot 100 identifies a lane on the shelf plate SL21 at the product replenishment destination of the stock shelf SL20, by the capture image data captured by the first camera 50L. Further, an image of the front side of the product replenishment shelf SL30 is captured by the first camera 50R, and the image data processing unit 155 of the product replenishment robot 100 identifies the position of each product placed on the product replenishment shelf SL30 by the capture image data captured by the first camera 50R. At the time of replenishing the product T from the product replenishment shelf to the stock shelf SL20, initially, the shelf plate SL21 of the stock shelf SL20 is placed in the first posture where the end of the front side (right side in the drawing) is higher than the end on the back side (left side in the drawing), and after replenishment is completed, the shelf plate SL21 is placed in the second posture where the end on the front side is lower than the end on the back side.

### <Structure and Operation of the Product Image Acquisition Apparatus 200>

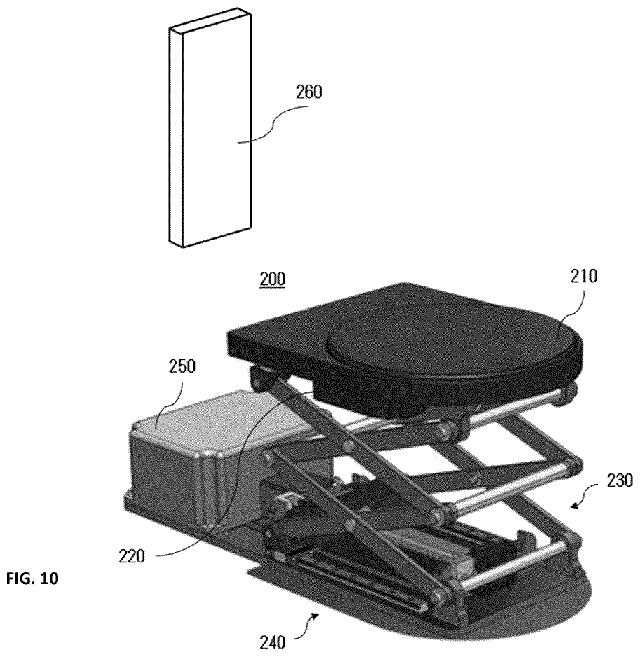

FIG. 10 is a perspective view showing the product image acquisition apparatus 200 included in the product replenishment system 1 of the present embodiment. The product image acquisition apparatus 200 includes a rotary base 210, a rotary drive unit 220, an elevation mechanism 230, an elevation drive mechanism 240, an elevation drive unit 250, and an image acquisition unit 260.

The rotary base 210 is configured to be rotatable about the central axis, and rotatable about the central axis together with the product placed on the rotary base 210. The rotary drive unit 220 includes a mechanism and a drive source for driving rotation of the rotary base 210, and for example, the drive source of the rotary drive unit 220 is an electric motor. The rotary base 210 may be configured to be directly coupled to the electric motor as the drive source, and driven rotationally, or may be driven rotationally by receiving the rotary drive force of the electric motor through drive transmission means such as a gear.

The elevation mechanism 230 is a mechanism which extends and retracts the rotary base 210 to elevate and lower the rotary base 210 such as a scissor-type linkage mechanism which is extended and retracted in the vertical direction. The elevation drive mechanism 240 is a drive mechanism for elevating/lowering the elevation mechanism 230. For example, the elevation drive mechanism 240 is configured to move one end of the lower side of the scissor mechanism of the elevation mechanism 230 back and forth in a direction toward the other end, and in a direction away from the other end. The elevation drive unit 250 includes a mechanism and a drive source for driving the elevation drive mechanism 240, and for example, the drive source of the elevation drive unit 250 is an electric motor.

The main body portion of the product image acquisition apparatus 200 made up of the rotary base 210, the rotary drive unit 220, the elevation mechanism 230, the elevation drive mechanism 240, and the elevation drive unit 250 is provided on the base plate 81 of the product replenishment robot 100, for example. Further, the rotary drive unit 220 and the elevation drive unit 250 are connected to the communication unit 195 of the control device 150 of the product replenishment robot 100 via wired connection or wireless connection, and drive control of these drive units (e.g., electric motors) is performed by the control device 150.

The image acquisition unit 260 has a function of obtaining an image of the outer periphery of the product placed on the rotary base 210, and for example, includes an image capture element for generating a capture image comprising pixels arranged two dimensionally (RGB image in one example). For example, the image acquisition unit 260 is provided on the elevation mechanism 90 forming a casing of the product replenishment robot 100.

While the product T held by the holder unit 10 of the product replenishment robot 100 is placed in front of the image acquisition unit 260 (position where the image is obtained by the image acquisition unit 260), or while the product placed on the rotary base 210 is rotated by the rotary base 210, by the rotary drive unit 220, the image acquisition unit 260 captures an image of the product. In the structure, the image acquisition unit 260 captures an image of the side surface or the outer peripheral surface of the product (image containing a product label, a barcode, etc. around the product), and obtains the image data. The image acquisition unit 260 transmits the obtained image data to the control device 150 through the communication unit 195 of the control device 150 of the product replenishment robot 100. After the image data processing unit 155 of the control device 150 receives the image data of the product, as described above, the image data processing unit 155 performs the process of identifying the type of the product, using the image data of the side surface or the outer peripheral surface of the product (image containing the product label, the barcode, etc. around the product). As described above, the product image acquisition apparatus 200 and the control device 150 function as a product identification system for identifying the type of the product held by the product replenishment robot 100. It should be noted that, since the product image acquisition apparatus 200 is mounted on the product replenishment robot 100, it is possible to place the product at the position where the image is obtained by the image acquisition unit 260, simply by operating the arm unit 20 after the product replenishment robot 100 holds the product.

(Image Acquisition and Identification Operation of the Product by the Product Image Acquisition apparatus 200)

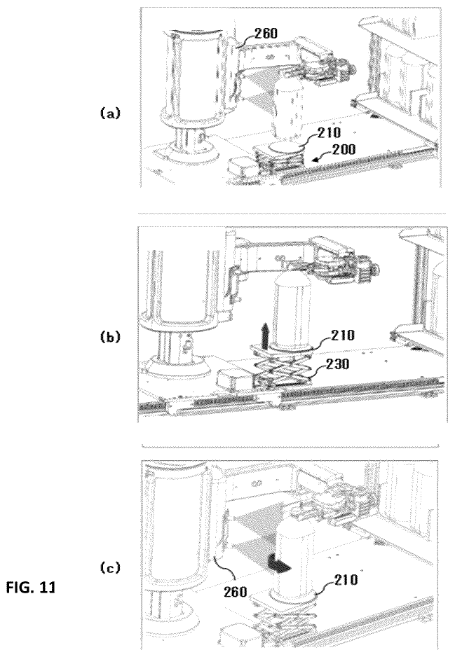

FIG. 11 is a view showing a series of operations of obtaining an image of the product T and identifying the product T by the product image acquisition apparatus 200.

In the product replenishment system 1, in the case of obtaining the image of the product T by the product image acquisition apparatus 200 for identifying the product T, as shown in FIG. 11(a), the product T is held by the holder unit 10 of the product replenishment robot 100, and moved to the height position above the rotary base 210 of the product image acquisition apparatus 200 where the image acquisition unit 260 of the product image acquisition apparatus 200 can capture the image of the side surface of the product T. Then, an image of the surface facing the image acquisition unit 260, in the side surface(s) of the product T, is captured by the image acquisition unit 260. The image data of the product T captured by the image acquisition unit 260 is transmitted through the communication unit 195 of the control device 150 of the product replenishment robot 100, to the control device 150 as described above, and the process of identifying the type of the product T by the control device 150 is performed by the control device 150 based on the image data (first product identification process). For example, the control device 150 identifies the type of the product T by the process of collating the image data transmitted to the control device 150 with the peripheral image data of various products stored in the memory unit 160 of the control device 150.

In the first product identification process, the image of one side surface of the product T held by the holder unit 10 of the product replenishment robot 100, and placed to face the image acquisition unit 260 is captured, and the process of identifying the type of the product T based on the image data is performed based on the image data. The portion of the side surface of the product T held by the holder unit 10 facing the image acquisition unit 260 for capturing the image can be determined arbitrarily. Therefore, in some cases, a surface in the side surface(s) of the product T which is not facing the front side of the label may be captured, and it may not be possible to perform the process of identifying the product T by the control device 150. In this case, in order to obtain the image data of the entire periphery of the side surface of the product T, the following second image capture operation is performed.

It should be noted that, in the example shown in FIG. 11(a), since the length of the product T in the longitudinal direction is relatively short, as a result of placing the product T at the position where the image acquisition unit 260 can capture the image of the product T, the bottom surface of the product T does not contact the rotary base 210 of the product image acquisition apparatus 200, and a gap is formed between the bottom surface of the product T and the rotary base 210. In this case, as shown in FIG. 11(b), the elevation mechanism 230 retracted to the lowermost position is extended by the elevation drive mechanism 240 and the elevation drive unit 250 until the rotary base 210 contacts the bottom surface of the product T. As a result, the bottom surface of the product T is placed on the rotary base 210. The contact of the rotary base 210 with the bottom surface of the product T can be detected based on the load generated in the elevation drive unit 250 (e.g., overcurrent applied to the electric motor) when the rotary base 210 contacts the bottom surface of the product T. It should be noted that, when the product T held by the holder unit 10 of the product replenishment robot 100 is moved to the height position above the rotary base 210 where the image acquisition unit 260 can capture the image of the product T, in the case where the bottom surface of the product T is placed on the rotary base 210, operation shown in FIG. 11(b) is not performed.

After the bottom surface of the product T is placed on the rotary base 210, holding of the product T by the holder unit 10 is temporarily released, and the rotary base 210 is rotated by the rotary drive unit 220. An image around the side surface of the product T rotated together with the rotary base 210 is captured by the image acquisition unit 260. As described above, the image data of the product T captured by the image acquisition unit 260 is transmitted to the control device 150 of the product replenishment robot 100 through the communication unit 195 of the control device 150, and the process of identifying the type of the product is performed by the control device 150 based on the image data (second product identification process). In the second product identification process, since the process of identifying the type of the product T is performed based on the image around the side surface of the product T, the accuracy of product identification is high in comparison with the first product identification process.

### <Structure of the Management Apparatus 300>

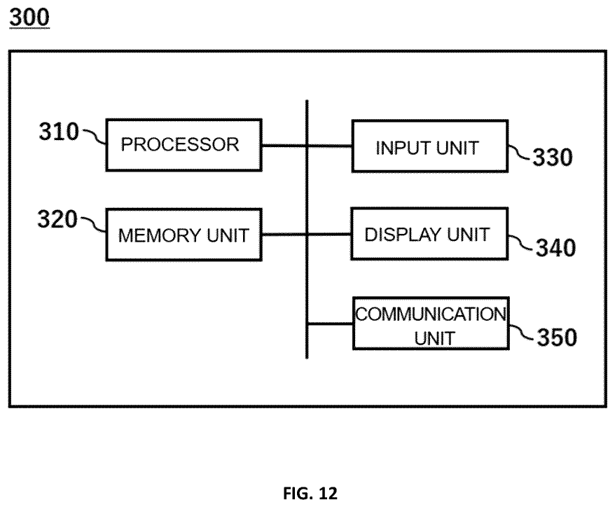

As shown in FIG. 12, the management apparatus 300 has a processor 310, a memory unit 320, an input unit 330, a display unit 340, and a communication unit 350. In FIG. 12, though the management apparatus 300 is drawn as a single element, the management apparatus 300 does not necessarily have to be a physically single element, but may be composed of a plurality of elements that are physically separated from each other.

The input unit 330 is a device for receiving input from the operator of the management apparatus 300. The input unit 330 may be made up of devices such as a keyboard, a mouse, a touch panel, etc. The display unit 340 is a display device for displaying a display screen generated by the processor 310. For example, the display unit is a liquid crystal display or an organic EL display device. The communication unit 350 communicates with the control device 150 of the product replenishment robot 100 and the terminal device 400, and inputs/outputs information, control signals, etc. between these components.

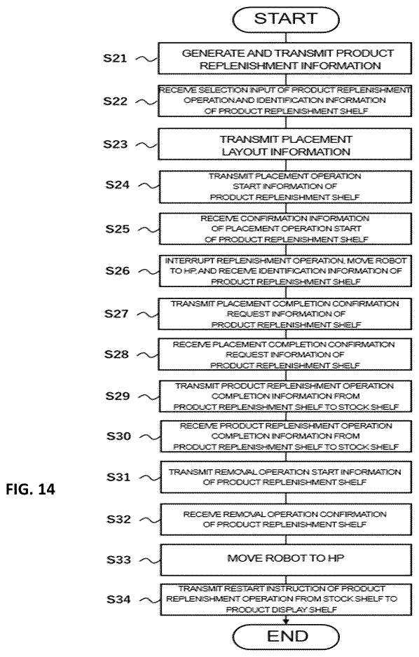

The memory unit 320 includes a transitory or non-transitory storage medium such as a ROM (Read Only Memory), a RAM (Random Access Memory), an HDD (Hard Disk Drive), or an SSD (Solid State Drive). The memory unit 320 stores computer programs executed by the processor 155. The computer programs stored in the memory unit 320 include an instruction for performing information processing by the processor 310, described later with reference to FIG. 14, etc. Further, the memory unit 160 at least temporarily stores information received from the control device 150 and/or the terminal device 400, or various items of data (including intermediate generated data) generated by processing operations by the processor 310.

The memory unit 320 also stores past sales data for each product in each store, for example. The sales data includes information such as the date and time of sale, and the quantity sold for each product. These items of sales data can be used as statistical information to predict which products should be replenished on the display shelves SL10 and stock shelves SL20, and according to what time schedule in each store. The memory unit 320 may further store a learned model generated by performing machine learning using such sales data on the learning device. Such a learned model can be used as a sales prediction model for generating schedules for replenishing products in the store.

The processor 310 is made up of one, or two or more CPUs (Central Processing Unit). The processor 310 operates to realize processes and functions performed by the processor 310 as described with reference to FIG. 14. In particular, the processor 310 uses past sales data or a learned model for sales prediction stored in the memory unit 320 to predict which products should be replenished on the product display shelf SL10 and the stock shelf SL20, and according to what time schedule in each store, and based on this prediction, the processor 310 schedules the type and quantity of the product to be replenished to the stock shelf SL20, along with the replenishment timing, and generates product replenishment information.

The product replenishment information includes placement layout information for products to be replenished from the product replenishment shelf SL30 to the stock shelf SL20 at a certain replenishment timing. The placement layout information includes the loading position and the loading quantity of each product loaded to each area on the product replenishment shelf SL30 where the products are loaded. The placement layout information may include shelf designation information designating the product replenishment shelf SL30 where the products should be loaded.

The generated product replenishment information is transmitted from the communication unit 350 to the control device 150 and the terminal device 400. The terminal device 400 displays the received placement layout information on the display screen, for the user of the terminal device 400. For the designated certain product replenishment shelf SL30, the store employee places the designated quantities of the designated various products onto the respective designated areas on the designated product replenishment shelf SL30, in accordance with the placement layout information displayed on the terminal device 400.

### <Structure of the Terminal Device 400>

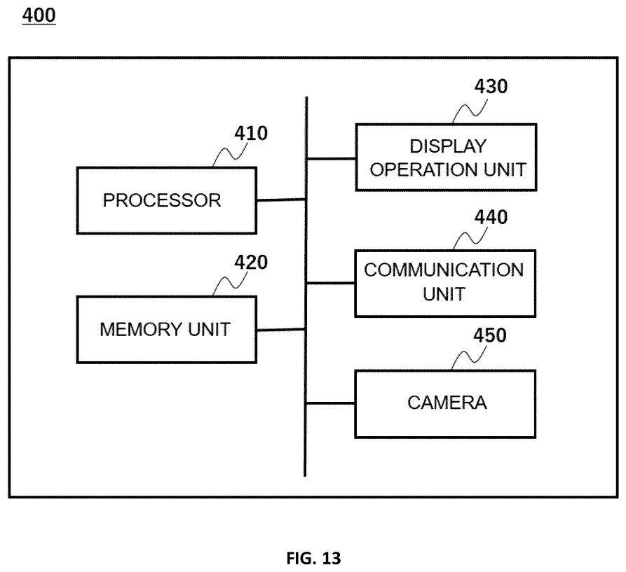

As shown in FIG. 13, the terminal device 400 includes a processor 410, a memory unit 420, a display operation unit 430, a communication unit 440, and a camera 450. It should be noted that this structure is given as an example. The terminal device 400 may have other structure.

The processor 410 executes a program stored in the memory unit 420 to control the overall operation of the terminal device 400, and the processor 410 is made up of a CPU, a GPU, etc. The processor 410 operates to perform the processes and the functions of the processor 410 as described with reference to FIG. 14.

The memory unit 420 stores a program for performing various control processes and various functions of the processor 410, and input data, etc. The memory unit 420 is made up of a RAM, a ROM, and other storages, etc. Further, the memory unit 420 temporarily stores communication content with other terminals. Specifically, the memory unit 420 stores a program which causes the processor 410 to execute the processes performed by the terminal device 400, as described with reference to FIG. 14.

The display operation unit 430 is a user interface used for the user of the terminal device 400 to input instructions and to display text, images, etc., in response to the display process performed by the processor 410. In the case where the terminal device 400 is a tablet terminal, etc., the display operation unit 430 is made up of a touch panel, etc.

The communication unit 440 is a communication interface for communicating with the control device 150 and the management apparatus 300 through a network.

The camera 450 is mainly used for reading a label attached to the product replenishment shelf SL30. The label contains characters, two-dimensional codes, etc. as identification information for identifying the product replenishment shelf SL30. The memory unit 420 also stores a character recognition program for recognizing characters, two dimensional codes, etc. read by the camera 450, and a program for decoding codes read by the camera 450.

The processor 410 displays product replenishment information received from the management apparatus 300 on the display operation unit 430. For the designated certain product replenishment shelf SL30, the store employee places the designated various products in the designated quantities at the respective designated positions on the designated product replenishment shelf SL30, in accordance with the placement layout information displayed on the terminal device 400. The store employee captures an image of the identification label attached to the designated certain product replenishment shelf SL30 by the camera 450 of the terminal device 400. The processor 410 transmits image data of the identification label captured by the camera 450 to the management apparatus 300 through the communication unit 440.

### <Operation Example>

Next, an operation example of the product replenishment system 1 of the present embodiment will be described. FIG. 14 is a flow chart illustrating an operation example of the product replenishment system 1 according to the present embodiment.

Firstly, in step S21, the processor 310 of the management apparatus 300 of the product replenishment system 1 predicts a time schedule for replenishing each product on the product display shelf SL10 and the stock shelf SL20 in each store using the past sales data or the learned model for sales prediction stored in the memory unit 320 of the management apparatus 300, and based on this prediction, the processor 310 schedules the type and quantity of the product to be replenished to the stock shelf SL20 in the store as the target of product replenishment, along with the replenishment timing, and generates product replenishment information.

The product replenishment information is related to the products to be replenished from the product replenishment shelf SL30 to the stock shelf SL20 at a certain replenishment timing, and includes placement layout information including the loading position and the loading quantity of each product in each area on the product replenishment shelf SL30 where the products are to be loaded. The placement layout information may contain information for designating the product replenishment shelf SL30 where the products should be loaded.

The generated product replenishment information is transmitted from the communication unit 350 to the control device 150 and the terminal device 400. Therefore, the control device 150 of the product replenishment robot 100 recognizes, based on the product replenishment information including the placement layout information, at which replenishment timing the product T placed on the designated product replenishment shelf SL30 in accordance with the placement layout information should be replenished to the stock shelf SL20. Further, the terminal device 400 which has received the product replenishment information displays the product replenishment information on the display operation unit 430, and enables the store employee who uses the terminal device 400 to recognize the product replenishment information.

Next, in step S22, the processor 410 of the terminal device 400 displays the product replenishment information transmitted from the management apparatus 300 in step S21 on the display operation unit 430 of the terminal device 400, and performs the process of receiving a selection input for the product replenishment operation on the display operation unit 430 by the store employee. The processor 410 of the terminal device 400 generates a display screen to be displayed on the display operation unit 430, based on the product replenishment information transmitted from the management apparatus 300.

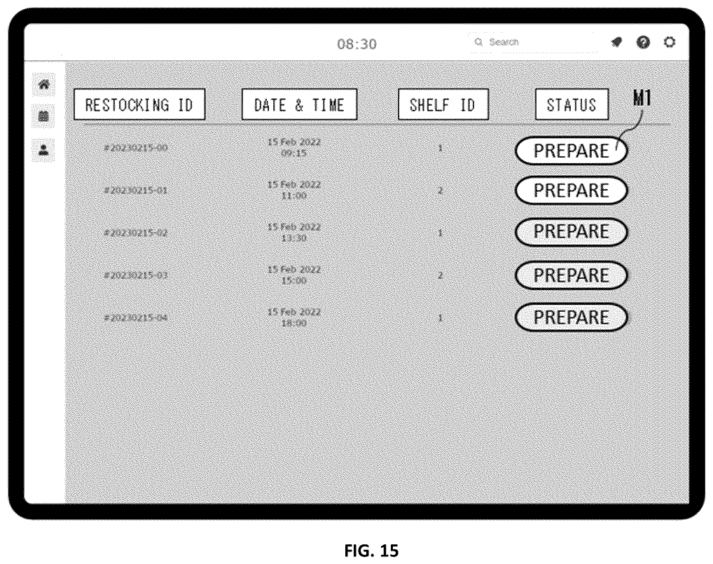

FIG. 15 is a view showing an example of a display screen of product replenishment information displayed on the display operation unit 430 of the terminal device 400. As display items of the product replenishment information, the example shown in FIG. 15 includes “RESTOCKING ID”, “DATE & TIME”, “SHELF ID”, and “STATUS”.

The “RESTOCKING ID” is information identifying each of the scheduled product replenishment operations. The “DATE & TIME” is information indicating the date and time when the product replenishment shelf SL30 loaded with the product for replenishment is placed at the product replenishment position in the store.

The “SHELF ID” is information identifying the product replenishment shelf SL30 used for the product replenishment operation designated by the “RESTOCKING ID”. In the example of FIG. 15, the product replenishment shelf SL30 of one of the IDs “1” and “2” is designated corresponding to each “RESTOCKING ID”.

The “STATUS” shows information instructing operation which should be performed by the store employee for the product replenishment shelf SL30. In this example, four types of operation instruction information, “PREPARE”, “LOAD”, “LOADED”, and “UNLOAD” are displayed in the “STATUS”. The “PREPARE” is operation instruction information for placing various items of products in accordance with to the placement layout information on the product replenishment shelf SL30 having the “SHELF ID” indicated by the “RESTOCKING ID”. The “LOAD” is placement operation instruction information for placing the product replenishment shelf SL30 where various items of products are placed in accordance with the instruction of the “PREPARE” at a predetermined position in the store. The “LOADED” is information indicating that the product replenishment shelf SL30, loaded with various products, is placed at the predetermined position in the store. The “UNLOAD” is removal operation instruction information for removing the product replenishment shelf SL30, which has become empty after the product replenishment from the product replenishment shelf SL30 to the stock shelf SL20 has been completed by the product replenishment robot 100, from the predetermined position of the backyard in the store. The display portions of the “PREPARE,” “LOAD,” “LOADED,” and “UNLOAD” in the “STATUS” can be selected by the click operation of the user on the display operation unit 430 when the display portions are active.

In the example of FIG. 15, four product replenishment operations are scheduled, and the “STATUS” for the two most recent operations at the top is in the active “PREPARE” state which requires placement of products onto each product replenishment shelf SL30. The display for the active “PREPARE” state may sequentially change color from blue to orange, and then to red as the time designated by the “DATE & TIME” for placing the product replenishment shelf SL30 at the product replenishment position in the store approaches. For example, the color may change at time points such as more than 30 minutes before, 30 minutes before, and 15 minutes before the designated time. In this manner, the store employee can be visually prompted to start operation of placing products onto the product replenishment shelf SL30.

On the other hand, for the replenishment operations where the timing to place products onto the product replenishment shelf SL30 has not yet arrived, the “STATUS” is set to “PREPARE” in a non-active (disabled) state. Therefore, for the replenishment operations where the timing to place the product on the replenishment shelf SL30 has not yet arrived, the display portion of the “PREPARE” cannot be selected.

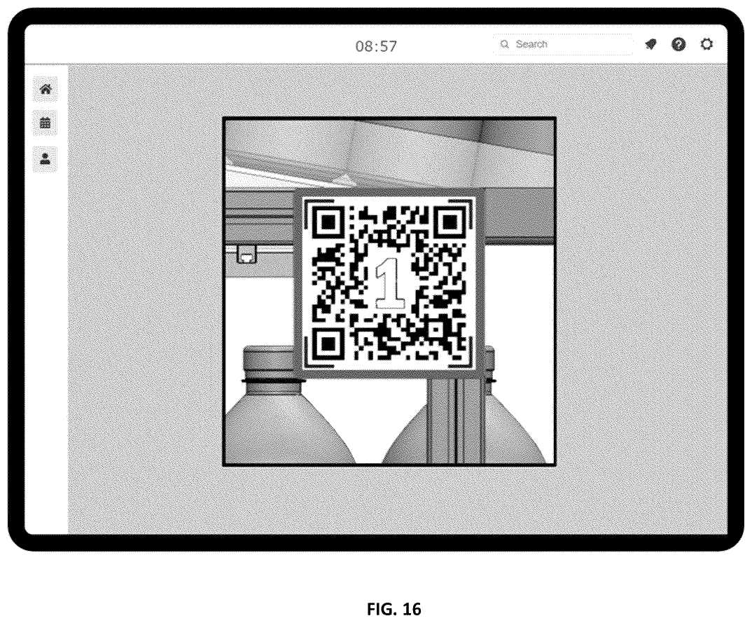

As shown in FIG. 15, the store employee performs a selection operation by clicking the display portion M1 labeled “PREPARE” in the active “STATUS” corresponding to the “RESTOCKING ID” for the replenishment operation to be performed, from the replenishment information displayed on the display operation unit 430 of the terminal device 400. Then, the processor 410 of the terminal device 400 activates the camera 450. Then, the store employee operates the terminal device 400 to capture an image of the identification information (label containing characters, two-dimensional codes, etc.) attached to the product replenishment shelf SL30 designated by the “SHELF ID” information associated with the “RESTOCKING ID” using the camera 450 of the terminal device 400. FIG. 16 shows a state where identification information of the product replenishment shelf SL30, captured by the camera 450 of the terminal device 400, is displayed on the display operation unit 430 of the terminal device 400. The “RESTOCKING ID” information associated with “PREPARE” selected as described above and image data of the identification information attached to the product replenishment shelf SL30 captured by the camera 450 are transmitted from the terminal device 400 to the management apparatus 300.

Next, in step S23, the processor 310 of the management apparatus 300 transmits the placement layout information associated with the “RESTOCKING ID” selected in step S22 to the terminal device 400, and displays the placement layout information on the display operation unit 430.

The processor 310 of the management apparatus 300 performs the character recognition process or the code decoding process for the image data of the identification information (label containing characters, two-dimensional codes, etc.) captured by the camera 450. The processor 310 of the management apparatus 300 determines whether or not the identification information captured by the camera 450 matches the “SHELF ID” associated with the “RESTOCKING ID” selected as described above to perform the product replenishment operation. If the processor 310 determines that both match, the processor 310 displays the placement layout information included in the product replenishment information associated with the “RESTOCKING ID” on the display operation unit 430 of the terminal device 400. Further, in the product replenishment information displayed on the display operation unit 430 of the terminal device 400, the processor 310 changes the display portion M1 of “STATUS” associated with the selected “RESTOCKING ID” from “PREPARE” to “LOAD”. On the other hand, if the processor 310 determines that both do not match, the processor 310 displays a message such as “This is not the product replenishment shelf as the operation target.” on the display operation unit 430 for a certain period of time, and thereafter, performs the process of returning the display on the display operation unit 430 to the display screen shown in FIG. 15.

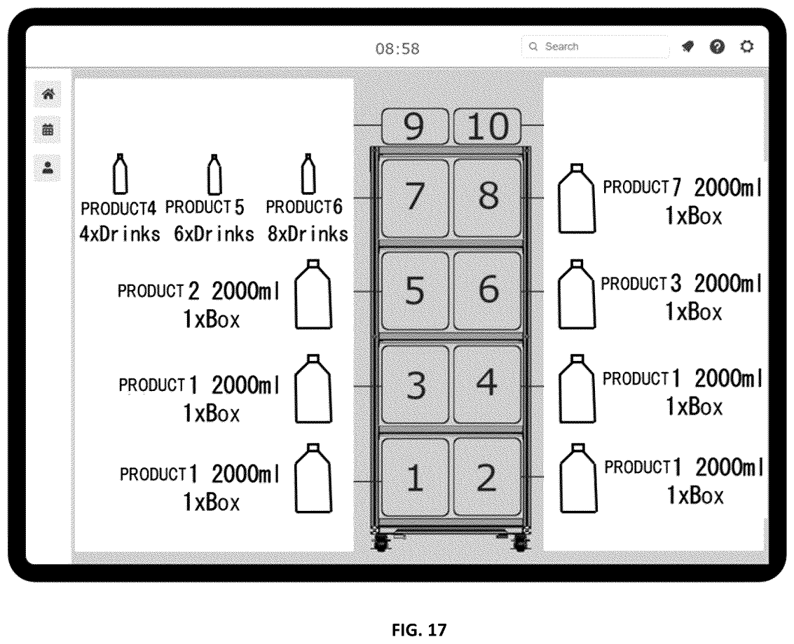

FIG. 17 is a view showing an example of the display screen of the placement layout information displayed on the display operation unit 430 of the terminal device 400. The placement layout information displayed on the display operation unit 430 shows the types and the number of products which should be placed on respective areas (from areas 1 to 10 in an example shown in FIG. 17) divided on respective shelf plates of the product replenishment shelf SL30 as the product placement target.

The store employee takes out various items of products stocked in the product stock location in the store (normally in the room temperature environment), and places the designated number of the designated products, respectively in the designated areas on the product replenishment shelf SL30, in accordance with the placement layout information displayed on the display operation unit 430 of the terminal device 400 as shown in FIG. 17. For example, in the case of placing products in a single shipping package in a designated area, the top and front portions of the shipping package are removed, and the remaining portion of the shipping package together with the products inside the shipping package can be placed in the designated area on the product replenishment shelf SL30 (e.g., areas 1 to 6 and 8 shown in FIG. 17). Alternatively, a plurality of types of products may be placed mixedly in a certain designated area (for example, an area 7 shown in FIG. 17).

When various items of products are placed on the product replenishment shelf SL30, operation of placing the products on the product replenishment shelf SL30 is completed, and it becomes possible to place the product replenishment shelf SL30 at the predetermined position in the store.

It should be noted that, as shown in FIG. 17, in the display screen of the placement layout information displayed on the display operation unit 430 of the terminal device 400, the display portion of each product is selectable by click operation on the display operation unit 430. For example, in the case where the designated product is out of stock such as when the product designated in the placement layout information does not exist in the product storage area in the store, or when fewer units than the designated quantity are stored, the store employee selects the product by click operation in the display screen of the placement layout information displayed on the display operation unit 430. Then, the processor 410 of the terminal device 400 displays the column accepting the change in the number of products, and accepts the input of numeric values on the display operation unit 430. When the store employee inputs the numerical values of the number of the products which can be placed on the display operation unit 430, the processor 410 of the terminal device 400 transmits the numerical value information regarding the product to the management apparatus 300. When the processor 310 of the management apparatus 300 receives the numeric value information regarding the product, the number of the products for placement in the placement layout information is updated according to the numeric value, and the product replenishment information including the updated placement layout information is transmitted to the control device 150.

Next, in step S24, the processor 310 of the management apparatus 300 transmits placement operation start information prompting the placement of the product replenishment shelf SL30, associated with the “SHELF ID” linked to the “RESTOCKING ID” selected in step S22, at a predetermined location in the store, to the terminal device 400, and causes the information to be displayed on the display operation unit 430.

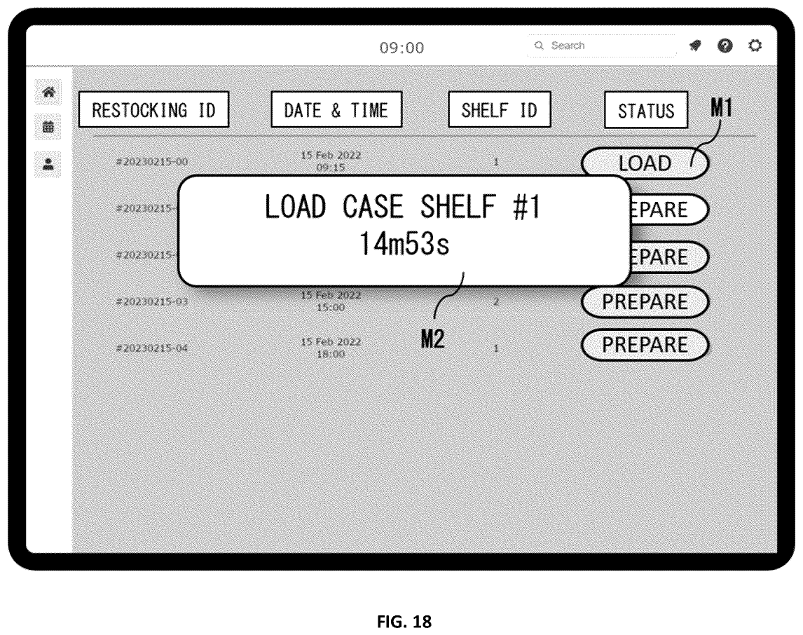

FIG. 18 is a view showing an example of operation start information displayed on the display operation unit 430 of the terminal device 400. In the example shown in FIG. 18, as the operation start information, a message of “LOAD CASE SHELF #1” prompting placement of the product replenishment shelf SL30 having the “SHELF ID” of #1 at a predetermined position in the store, is displayed as a relatively large display portion M2 on the display operation unit 430. The operation start information may include countdown timer display indicating the remaining time to the time at which the product replenishment shelf SL30 should be placed at the predetermined position in the store. In the example shown in FIG. 18, “14m53s” showing the remaining time of 14 minutes 53 seconds is displayed. When the predetermined time before the scheduled time (e.g., 15 minutes before the scheduled time) for placing the product replenishment shelf SL30 at the predetermined position in the store arrives, the operation start information is displayed on the display operation unit 430 of the terminal device 400. Firstly, the operation start information may be displayed in a first color (e.g., green), and thereafter, the first color may be changed gradually to a second color (e.g., red) when the remaining time becomes shorter. In this manner, the store employee who uses the terminal device 400 can be visually prompted to place the product replenishment shelf SL30 at the predetermined position by the scheduled time.

Then, in step S25, the processor 310 of the management apparatus 300 receives information from the terminal device 400 indicating that the store employee has confirmed the placement operation start information prompting the placement of the product replenishment shelf SL30 at the predetermined position in the store.

The display portion M2 of the operation start information displayed on the display operation unit 430 can be clicked by user's operation on the display operation unit 430. As shown in FIG. 18, when the store employee performs click operation of the display portion M2 of the placement operation start information displayed on the display operation unit 430 of the terminal device 400, the processor 410 of the terminal device 400 transmits information indicating that the operation start information has been confirmed by the user, to the management apparatus 300, and the management apparatus 300 receives the information.

Next, in step S26, when the processor 310 of the management apparatus 300 receives information indicating that the placement operation start information has been confirmed by the user, the processor 310 transmits the instruction for moving the product replenishment robot 100 to the home position to the control device 150 of the product replenishment robot 100. When the control device 150 receives the instruction, for example, the control device 150 interrupts the product replenishment operation from the stock shelf SL20 to the product display shelf SL10, performed by the product replenishment robot 100 at the time, and moves the product replenishment robot 100 to the home position. For example, the home position is a position adjacent to one end of the rail R shown in FIG. 2.

Further, when the processor 310 of the management apparatus 300 receives information indicating that the placement operation start information has been confirmed by the user, the processor 410 of the terminal device 400 activates the camera 450. Then, the store employee operates the terminal device 400 and captures identification information attached to the product replenishment shelf SL30 designated by the placement operation start information (label containing characters, two-dimensional codes, etc.) by the camera 450 of the terminal device 400. The store employee is requested to capture the identification information of the product replenishment shelf SL30 designated by the placement operation start information. This is intended to ensure that products are placed on the designated product replenishment shelf SL30 and that the product replenishment shelf SL30 is positioned at the predetermined position in the store without any mistake by the store employee. The image data of the identification information attached to the product replenishment shelf SL30 captured by the camera 450 is transmitted from the terminal device 400 to the management apparatus 300.

After the store employee performs the above operation using the terminal device 400, the store employee moves the product replenishment shelf SL30 to the predetermined position in the store, and places the product replenishment shelf SL30 at the predetermined position in the store. For example, the predetermined position is a position adjacent to the other end of the rail R shown in FIG. 2, i.e., a position adjacent to the rail R opposite to the home position of the product replenishment robot 100. The product replenishment robot 100 moves to the position adjacent to the other end of the rail R. So, the product replenishment robot 100 can hold and take out the product from the product replenishment shelf SL30 placed at the predetermined position.

Then, in step S27, the processor 310 of the management apparatus 300 transmits completion confirmation request information requesting completion confirmation that the product replenishment shelf SL30 of the “SHELF ID” indicated by the placement operation start information, has been placed at the predetermined position in the store, to the terminal device 400, to display the completion confirmation request information on the display operation unit 430.

The processor 310 of the management apparatus 300 performs the character recognition process or the code decoding process for the image data of the identification information of the product replenishment shelf SL30 (label containing characters, two-dimensional code, etc.) of the product replenishment shelf SL30 captured by the camera 450 and transmitted to the management apparatus 300 in step S26. The processor 310 determines whether or not the identification information captured by the camera 450 matches the “SHELF ID” associated with the “RESTOCKING ID” selected as described above for performing the product replenishment operation. In the case where the processor 310 determines that both match, the processor 310 transmits completion confirmation request information requesting completion confirmation that the product replenishment shelf SL30, indicated by the “SHELF ID” in the above placement operation start information, has been placed at the predetermined position in the store, to the terminal device 400, to display the completion confirmation request information on the display operation unit 430. On the other hand, in the case where the processor 310 determines that both do not match, for example, the processor 310 displays a message such as “This is not the target product replenishment shelf.” on the display operation unit 430 for a certain period of time, and then, performs the process of returning the display on the display operation unit 430 to the display screen shown in FIG. 18.

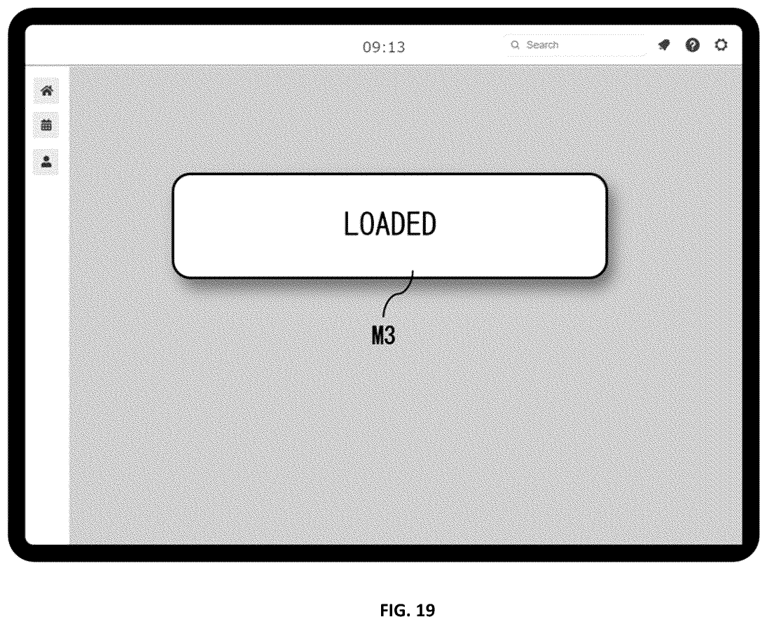

FIG. 19 is a view showing an example of completion confirmation request information displayed on the display operation unit 430 of the terminal device 400. In the example shown in FIG. 19, as the completion confirmation request information, “LOADED” which is an indication accepting confirmation that the product replenishment shelf SL30 has been placed at the predetermined position in the store, is displayed as a relatively large display portion M3 on the display operation unit 430. Click operation of the display portion M3 of the completion confirmation request information displayed on the display operation unit 430 can be performed by the user on the display operation unit 430.

Next, in step S28, the processor 310 of the management apparatus 300 receives completion confirmation information that the product replenishment shelf SL30 of the “SHELF ID” indicated by the placement operation start information has been placed at the predetermined position in the store, from the terminal device 400.

When the store employee moves and places the product replenishment shelf SL30 designated as described above at the predetermined position in the store, the store employee performs operation of clicking the display portion M3 of the completion confirmation request information displayed on the display unit 430 of the terminal device 400 as shown in FIG. 19. Then, the processor 410 of the terminal apparatus 400 transmits the completion confirmation information that the product replenishment shelf SL30 of the “SHELF ID” indicated by the operation start information has been placed at the predetermined position in the store, and the management apparatus 300 receives the completion confirmation information.

Next, in step S29, the processor 310 of the management apparatus 300 transmits an instruction for causing the product replenishment robot 100 to replenish the product on the product replenishment shelf SL30 placed at the predetermined position in the store onto the stock shelf SL20, to the control device 150 of the product replenishment robot 100. Further, when the processor 310 of the management apparatus 300 receives the above completion confirmation information, in the product replenishment information displayed on the display operation unit 430 of the terminal device 400, the processor 310 changes the display portion M1 of the “STATUS” associated with the “RESTOCKING ID” performing the product replenishment operation from the “LOAD” to the “LOADED”.

When the processor 310 of the management apparatus 300 receives the completion confirmation information, the processor 310 transmits an instruction for causing the product replenishment robot 100 to perform operation of moving the product on the product replenishment shelf SL30 placed at the predetermined position in the store to the stock shelf SL20 to the control device 150 of the product replenishment robot 100. When the control device 150 receives the instruction, the control device 150 operates the product replenishment robot 100, and operation of moving the product on the product replenishment shelf SL30 to the stock shelf SL20 is performed by the product replenishment robot 100.

Since the product replenishment information including the placement layout information is transmitted from the management apparatus 300 to the control device 150, the control device 150 has information about which products, and how many products are placed on which area on the product replenishment shelf SL30. Further, the control device 150 has information about which product should be replenished on which lane of the stock shelf SL20. Therefore, the control device 150 holds, and takes out a certain product from the product replenishment shelf SL30, and causes the product replenishment robot 100 to repeatedly perform operation of moving the product to the corresponding lane on the stock shelf SL20 corresponding to the product, and replenishes the stock shelf SL20 with the product on the product replenishment shelf SL30.

The product replenishment operation from the product replenishment SL30 to the stock shelf SL20 may be performed, for example, for all the products in each area in the placement layout described with reference to FIG. 14, or the operation of replenishing one or several products in each area in the placement layout may be repeated. More specifically regarding the latter case, for example, replenishment operation of replenishing three products for each area, from the area 1 to the area 8 successively may be repeated a plurality of times until there are no products left on the replenishment shelf SL30.

It should be noted that, since product replenishment operation from the product replenishment shelf SL30 to the stock shelf SL20 by the product replenishment robot 100 is the same as the operation described with reference to FIG. 9, the description thereof is omitted herein. As described above, in the case of replenishing the product T from the product replenishment shelf SL30 to the stock shelf SL20, the drive mechanism of the stock shelf SL20 places the stock shelf SL21 in a first posture where the end on the front side is higher than the end on the back side, according to the control signal transmitted from the communication unit of the control device 150 of the product replenishment robot 100 at the time of starting the operation of replenishing the product T from the product replenishment shelf SL30 to the stock shelf SL20. Thus, the product placed on the front side in the predetermined product row on the shelf plate SL21 for replenishment slips down toward the back side of the shelf plate SL21 along downward slope from the front side to the back side. Therefore, by repeating operation of placing the product on the front side of the shelf plate SL21, it is possible to successively replenish the product in the product row of the shelf plate SL21.

Further, after completing the product replenishment operation from the product replenishment shelf SL30 to the stock shelf SL20, the drive mechanism of the stock shelf SL20 places the shelf plate SL21 of the stock shelf SL20 in a second posture where the end of the front side is lower than the end of the back side, according to the control signal transmitted from the communication unit of the control device 150 of the product replenishment robot 100 after completion of the replenishment operation. As a result, the products placed in each product row of the shelf plate SL21 moves in a manner that the product slips down toward the front side of the shelf plate SL21 along the downward slope from the back side to the front side. Therefore, each time the frontmost product on the front side of the stock shelf SL20 is taken out from the stock shelf SL20 by the product replenishment robot 100 for replenishment, since the products on the back side is moved successively in a manner that the products slip down toward the front side of the shelf plate SL21, it becomes possible for the product replenishment robot 100 to take out the product positioned at the frontmost position on the front side of the stock shelf SL20 and move the product to the product display shelf SL10 for replenishment.

Further, in the product replenishment operation from the product replenishment shelf SL30 to the stock shelf SL20 by the product replenishment robot 100, the product image acquisition apparatus 200 may obtain the image of the product T with reference to FIGS. 10 and 11, and transmit the image data of the product to the control device 150 to perform the process of identifying the type of the product T by the control device 150 based on the image data (above first and second product identification processes). The product replenishment robot 100 may perform the product identification process for all of the products taken out from the product replenishment shelf SL30, or for some of products on the product replenishment shelf SL30.

Next, an example will be described with reference to the placement layout information shown in FIG. 17. Since products of a single type are placed in each box in each of areas 1 to 6 and 8 of the product replenishment shelf SL30, the possibility that a store employee will place the wrong product in the placement operation is low. Therefore, for the products placed in these areas, the product identification process may be omitted, or the product identification process may be performed for only the first one product. On the other hand, since a plurality of types of products are mixedly loaded in the area 7 of the product replenishment shelf SL30, as for the products placed in the area 7, it is preferable to perform the product identification process individually for all of the products.

Next, in step S30, when the product replenishment operation from the product replenishment shelf SL30 to the stock shelf SL20 by the product replenishment robot 100 is completed, the control device 150 transmits information indicating that product replenishment operation has been completed to the management apparatus 300, and the management apparatus 300 receives the information.

Next, in step S31, the processor 310 of the management apparatus 300 transmits removal operation start information prompting removal of the product replenishment shelf SL30 placed at the predetermined position in the store from this predetermined position, to the terminal device 400, and displays the removal operation start information on the display operation unit 430.

When the processor 310 of the management apparatus 300 receives information indicating that the product replenishment operation has been completed from the terminal device 400, in the product replenishment information displayed on the display operation unit 430 of the terminal device 400, the display portion M1 of the “STATUS” associated with the “RESTOCKING ID” for which the product replenishment operation has been performed is changed from “LOADED” to “UNLOAD”. This “UNLOAD” corresponds to removal start information prompting removal of the product replenishment shelf SL30 placed at the predetermined position in the store from this predetermined position.

Next, in step S32, the processor 310 of the management apparatus 300 receives removal confirmation information indicating that the product replenishment shelf SL30 of the “SHELF ID” associated with the “RESTOCKING ID” selected as described above to perform the product replenishment operation has been removed from the predetermined placement position, from the terminal device 400.

When the store employee performs operation of clicking the display portion of the “UNLOAD” displayed on the display operation unit 430 of the terminal device 400, the processor 410 of the terminal device 400 transmits information indicating that user has operated the “UNLOAD”, to the management apparatus 300, and the management apparatus 300 receives the information. This information corresponds to confirmation information that the product replenishment shelf SL30 of the “SHELF ID” associated with the “RESTOCKING ID” as selected above to perform the product replenishment operation has been removed from the predetermined placement position of the product replenishment shelf SL30.

Next, in step S33, the processor 310 of the management apparatus 300 transmits an instruction for moving the product replenishment robot 100 to the home position, to the control device 150 of the product replenishment robot 100.

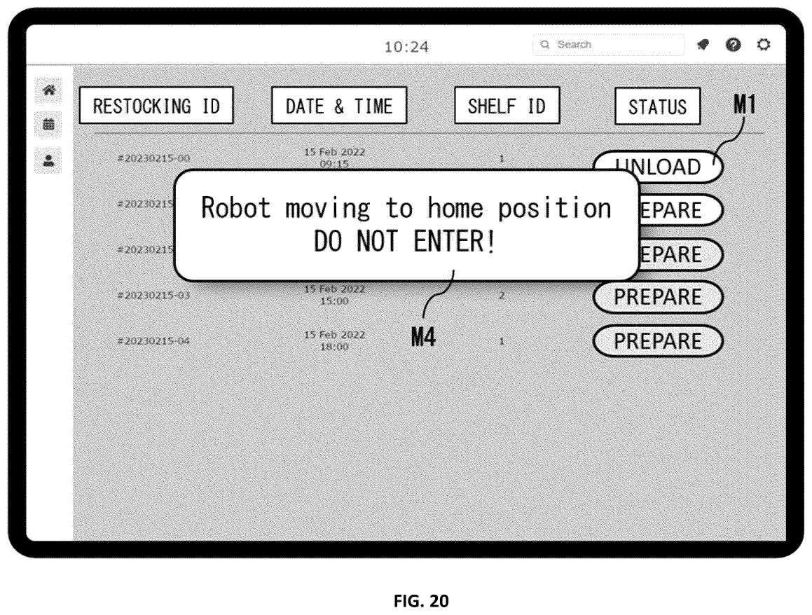

When the control device 150 receives the instruction, the control device 150 moves the product replenishment robot 100 to the home position. While the product replenishment robot 100 is moving to the home position, the processor 310 of the management apparatus 300 may display a warning message M4 as shown in FIG. 20 on the display operation unit 430 of the terminal device 400. In the example shown in FIG. 20, while the product replenishment robot 100 is moving to the home position, a message prohibiting the store employee from entering the operational area of the product replenishment robot 100 between the product display shelf SL10 and stock shelf SL20 is displayed.

When the product replenishment robot 100 moves to the home position, information indicating that the product replenishment robot 100 has moved to the home position is transmitted from the control device 150 to the management apparatus 300, and the processor 310 of the management apparatus 300 finishes this message display on the display operation unit 430 of the terminal device 400. As a result, it become possible for the store employee to remove the product replenishment shelf SL30 from the predetermined position in the store where the product replenishment shelf SL30 is placed, and as necessary, enter the operation area of the product replenishment robot 100 (normally, low temperature environment for cooling the products) between the product display shelf SL10 and the stock shelf SL20 as necessary.

Lastly, in step S34, the processor 310 of the management apparatus 300 transmits an instruction to the control device 150 to resume the product replenishment operation from the stock shelf SL20 to the product display shelf SL10 by the product replenishment robot 100.

After the store employee removes the product replenishment shelf SL30 from the predetermined position in the store, for example, when the store employee performs operation of clicking the display portion of the “UNLOAD” displayed on the display operation unit 430 of the terminal device 400 again, the processor 410 of the terminal device 400 transmits information indicating that the “UNLOAD” is operated by the user again, to the management apparatus 300. Then, the processor 310 of the management apparatus 300 transmits an instruction of operating the product replenishment robot 100 to resume the product replenishment operation from the stock shelf SL20 to the product display shelf SL10, to the control device 150. When the control device 150 receives the instruction, the control device 150 causes the product replenishment robot 100 to resume the product replenishment operation from the stock shelf SL20 to the product display shelf SL10. The product replenishment operation from the stock shelf SL20 to the product display shelf SL10 by the product replenishment robot 100 is continuously performed until the next scheduled product replenishment operation to the stock shelf SL20 is started.

As described above, in the product replenishment system according to the present embodiment, the placement layout, including various products and the number of the products placed on the replenishment shelf SL30 for products to be replenished to the stock shelf SL20, is generated by the management apparatus 300 according to the product replenishment schedule for the stock shelf SL20 and presented to the store employee through the terminal device 400. The store employee places the various items of products on the product replenishment shelf SL30 according to the placement layout displayed on the display operation unit 430 of the terminal device 400, and the product replenishment shelf SL30 is positioned at the predetermined position in the store. Thereafter, the product replenishment robot 100 controlled by the control device 150 successively moves the various items placed on the product replenishment shelf SL30 to the corresponding product row on the stock shelf SL20 to replenish the products from the product replenishment shelf SL30 to the stock shelf SL20. After the product replenishment robot 100 completes replenishment of the products from the product replenishment shelf SL30 to the stock shelf SL20, the product replenishment from the stock shelf SL20 to the product display shelf SL10 is resumed until the next scheduled product replenishment from the product replenishment shelf SL30 to the stock shelf SL20 is started. In this manner, in the product replenishment system according to the present disclosure, in addition to replenishment of the products from the stock shelf SL20 to the product display shelf SL10, it is possible to replenish the products to the stock shelf SL20 by the product replenishment robot. Thus, it becomes possible to reduce the burden required for the store employee to perform the product replenishment operation.

Further, in the product replenishment system according to the embodiment, it is possible to replenish products to the stock shelf by the product replenishment robot. Therefore, in comparison with the case of replenishing the products to the stock shelf by the store employee, it is possible to improve the utilization rate of the product replenishment system.

### Second Embodiment

Next, the second embodiment according to the present disclosure will be described. In the above described first embodiment, an example where the store employee placed the products on the product replenishment shelf SL30, in accordance with the placement layout presented by the terminal device 400 has been shown. In this example, since the store employee may mistakenly place the product at a wrong position, the product replenishment robot 100 is equipped with a product image acquisition apparatus 200 as means for identifying products during replenishment operation from the product replenishment shelf SL30 to the stock shelf SL20, serving as means to compensate for such mistakes. The present embodiment provides means which makes it possible to flexibly perform the operation of placing the products on the product replenishment shelf, and improve the accuracy in the efficiency of the product replenishment operation of the system as a whole.

The product replenishment system in the present embodiment may have the same structure as the product replenishment robot 100, the control device 150, the management apparatus 300, and the terminal device 400 included in the product replenishment system 1 of the first embodiment. However, in the present embodiment, the product image acquisition apparatus 200 in the first embodiment may be omitted.

### <Structure of the Product Replenishment Shelf SL130>

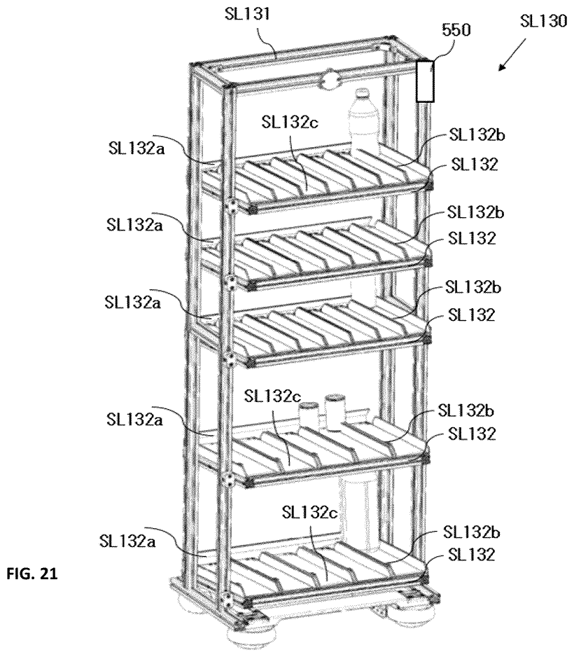

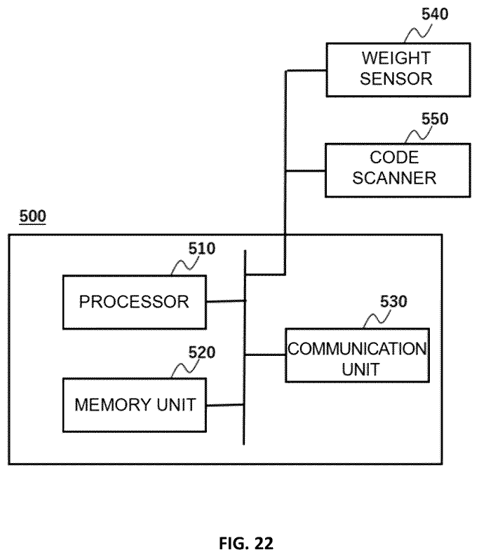

Next, structure of the product replenishment shelf SL130 in the present embodiment will be described. The product replenishment shelf SL130 in the present embodiment replaces the product replenishment shelf SL30 in the first embodiment. FIG. 21 is a perspective view showing overall structure of a product replenishment shelf according to the second embodiment of the present disclosure. FIG. 22 is a block diagram showing a control unit provided in the product replenishment shelf shown in FIG. 21.

As shown in FIG. 21, the product replenishment shelf SL130 in this embodiment comprises a frame structural body SL131 forming the overall framework and a plurality of shelf plates SL132 provided on the frame structural body SL131. Each shelf plate SL132 is installed with a slight downward slope from the front side in the drawing where products are placed and removed, toward the back side in the drawing. A stopper SL132a is provided on the back side in the drawing, of each of the shelf plates SL132, for preventing the products from being dropped from the shelf plate SL132 after the products are placed on the front side in the drawing and slid along the slope toward the back side in the drawing.

Further, a plurality of partition plates SL132b for dividing the product lanes are provided in each of the shelf plates SL132, and a plurality of floor plates SL132c having the weight sensors 540 (see FIG. 22) respectively are provided individually for each product lane. The weight sensor 540 may adopt any known structure, such as a load cell type, a piezoelectric element type, or a capacitive type. Each weight sensor 540 is assigned with identification information corresponding to each product lane of the shelf plate SL132 where the weight sensor 540 is installed. Therefore, it is possible to measure the weight of the products placed on each of the product lanes where each weight sensor 540 is installed on the shelf plate SL132. It should be noted that the weight sensor 540 is one of the product placement sensors as means for detecting that the product has been placed on the product lane of the shelf plate SL132. As the product placement sensor, an optical sensor, etc. may be used instead of the weight sensor 540.

Further, the product replenishment shelf SL130 is provided with a code scanner 550 for scanning codes (including a barcode, a two-dimensional code, etc.) attached to the outer peripheral surface of the container of the product. For example, the code scanner 550 is configured to radiate a laser beam to the code attached to the product, and receive the reflected beam to read product information (including the type, the capacity, etc. of the product) indicated by the code.

The product replenishment shelf SL130 is provided with a plurality of casters SL133 for enabling movement of the product replenishment shelf SL130 on the store floor, on the lower side of the frame structural body SL131. For example, in the present embodiment, the casters SL133 in the form of balls are provided at four corners on the lower side of the frame structural body SL131.

### <Structure of the Control Unit 500>

As shown in FIG. 22, the control unit 500 provided for the product replenishment shelf SL130 includes a processor 510, a memory unit 520, and a communication unit 530. It should be noted that the structure is an example, and may have other structure. The above described weight sensors 540 and the code scanner 550 are connected to the control unit 500 in a manner that the weight sensors 540 and the code scanner 550 can communicate with the control unit 500.

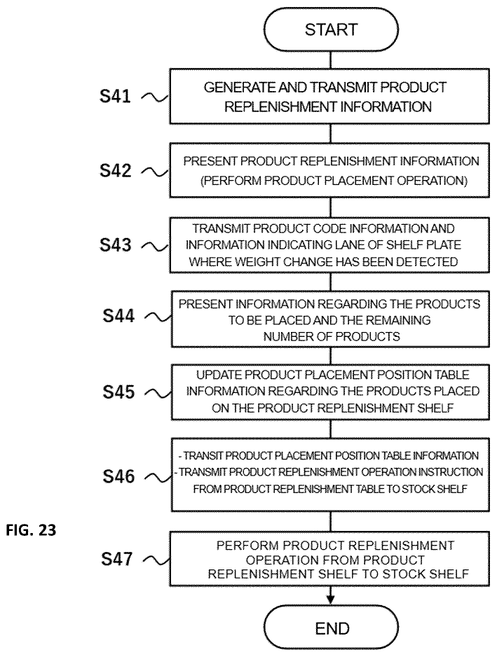

The processor 510 controls the overall operation of the control device 500 by performing a program stored in the memory unit 520, and made up of a CPU, a GPU, etc. The processor 510 operates to perform the processes and/or the functions performed by the processor 510 described with reference to FIG. 23.

The memory unit 520 stores various control processes, programs for the processor 510 to execute respective functions, input data, and the like, and is constituted by a RAM, a ROM, and other storage devices. Furthermore, the memory unit 520 temporarily stores communication contents with other terminals, the weight sensor 540, and the code scanner 550. In particular, the memory unit 520 stores a program for causing the processor 510 to execute the processes performed by the control device 500, which will be described with reference to FIG. 23.

The communication unit 530 is a communication interface for communicating with the terminal device 400 through a network.

The processor 510 transmits data related to the weight of an object placed on each product lane, as measured by each weight sensor 540, to the terminal device 400 through the communication unit 530. Further, the processor 510 transmits information about the code read by the code scanner 550 to the terminal device 400.

### <Operation Example>

Next, an operation example of the product replenishment system according to the present embodiment will be described. FIG. 23 is a flow chart illustrating an operation example of the product replenishment system according to the second embodiment.

Firstly, in step S41, the processor 310 of the management apparatus 300 of the product replenishment system 1 predicts a time schedule for replenishing each product on the display shelve SL10 and the stock shelve SL20 in each store using the past sales data or the learned model for sales prediction stored in the memory unit 320 of the management apparatus 300, and based on this prediction, the processor 310 schedules the type and quantity of the product to be replenished to the stock shelf SL20 in the store as the target of product replenishment, and generates product replenishment information. The product replenishment information is related to the product to be replenished from the product replenishment shelf SL130 to the stock shelf SL20. The generated product replenishment information is transmitted from the communication unit 350 of the management apparatus 300 to the terminal device 400.

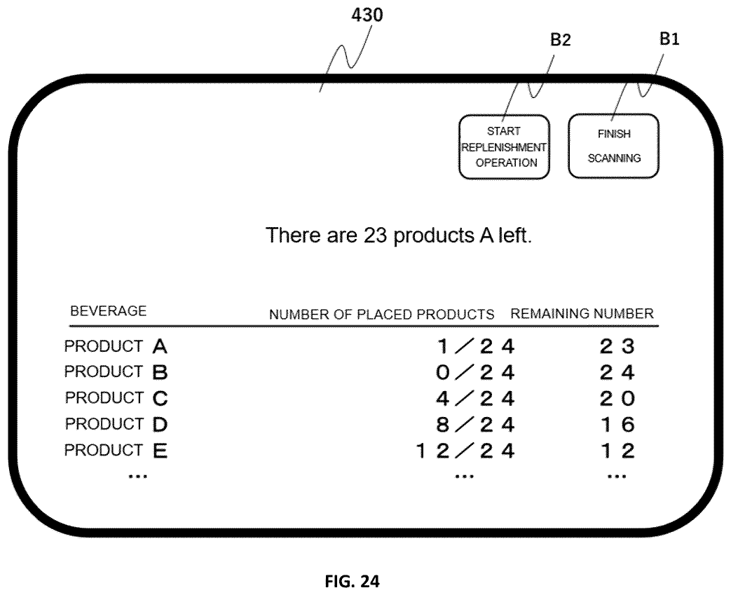

Next, in step S42, the terminal device 400 which has received the product replenishment information displays the product replenishment information on the display operation unit 430, and presents the product replenishment information to the store employee who uses the terminal device 400. FIG. 24 shows an example of the product replenishment information displayed on the display operation unit 430 of the terminal device 400. As shown in FIG. 24, the product replenishment information includes information regarding the type and quantity of the product to be placed on the product replenishment shelf SL130.

The store employee performs operation of placing the products of the types designated by the presented product replenishment information, by the designated number of products, on the product replenishment shelf SL130. The operation of placing the products on the product replenishment shelf SL130 includes placement of the products on an arbitrary product lane of an arbitrary shelf plate SL131 of the product replenishment shelf SL130, after causing the code scanner 550 to read a code of the product taken out from a package box by the operator.

In step S43, a processor 501 of the control unit 500 obtains product code information read by a code reading process performed by the code scanner 550, and information indicating a product lane of the shelf plate SL131 in which a weight change is detected by a weight sensor 540 as a result of placement of the product after the code reading process, and associates these items of data each other and transmits the data from the communication unit 530 to the terminal unit 400. This process operation is repeatedly performed for each of the products. Further, each time the process of reading the code is performed by the code scanner 550, the processor 501 transmits numeric data of the total weight of products on each product lane, measured by each of the weight sensors installed on each product lane of each shelf plate SL131, from the communication unit 530 to the terminal device 400.

Next, in step S44, among the products included in the product replenishment information, for the product identified by the received code information, the processor 410 of the terminal device 400 which received the above information increments the “placed number” by 1 and decrements the “remaining number” by 1, and displays the quantity after these calculations on the display operation unit 430 and outputs the voice such as “the remaining replenishment quantity of the products A is X” from a speaker (not shown) of the terminal device 400. For example, when the initial remaining number of product A to be placed is twenty four, upon receipt of code information regarding the product A by the terminal device 400, the processor 410 increments the “placed number” of the product A in the product replenishment information by 1 and decrements the “remaining number” by 1. The processor 410 then causes the display operation unit 430 to display the calculated values, i.e., the “placed number” of 1 and the “remaining number” of 23, and further causes the speaker (not shown) of the terminal device 400 to output a voice message “The remaining replenishment quantity of the product A is 23.” Further, as shown in FIG. 24, the processor 410 may display the character information such as “There are 23 products A left.” on the display operation unit 430. These processes are performed each time the terminal device 400 receives the code information. Further, for a product among the products included in the product replenishment information stored in the memory unit 420 for which a change has occurred in the “placed number” and the “remaining number”, the processor 410 updates these numbers to the changed values.

Next, in step S45, following the process of step S44, or in parallel with the process of step S44, the processor 410 of the terminal device 400 which has received the above information updates the product placement position table information, which is information regarding the type and position of one or more products placed on each shelf plate SL131 of the product replenishment shelf SL130. In the terminal device 400 of the present embodiment, this product placement position table information is stored in the memory unit 420, and the product placement position table information is updated each time the terminal device 400 receives the above information from the control unit 500.

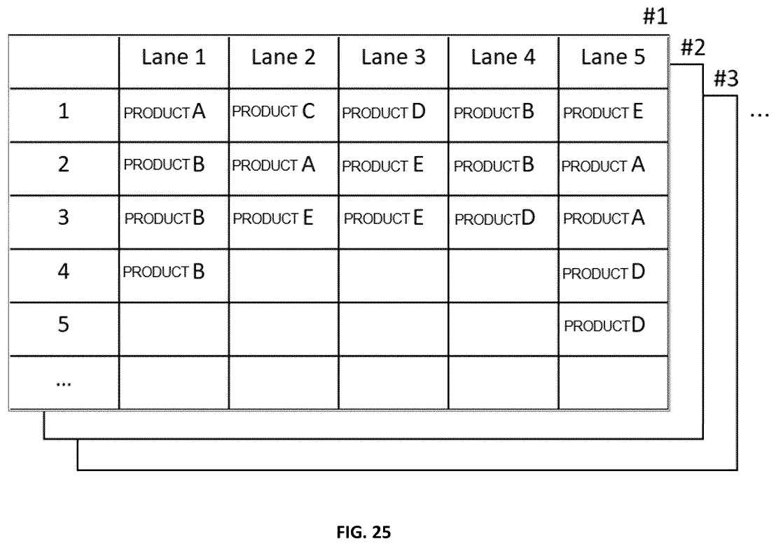

FIG. 25 is a view showing an example of the product placement position table information. The product placement position table information includes information regarding each shelf plate SL131 of the product replenishment shelf SL130, about which type of product is positioned at which position. In FIG. 25, details of the product placement position table information regarding the shelf plate SL131 of the shelf number #1 are shown as an example.

When the processor 410 of the terminal device 400 receives, from the control unit 500, code information of the product read in the code reading process by the code scanner 550, and information indicating the product lane of the shelf plate SL131 in which a weight change is detected by the weight sensor 540 as a result of placement of the product after the code reading process, the processor 410 of the terminal device 400 counts the order in which information is received for the product lane of the shelf plate SL131, associates the shelf plate SL131, the product lane, and the determined order number with the product information indicated by the code information, and updates the product placement position table information stored in the memory unit 420.

With reference to the example shown in FIG. 25, when the terminal device 400 receives, for example, code information indicating the product C and information indicating the second product lane (Lane 2) of the shelf plate SL131 of shelf number #1 where a weight change is detected, the processor 410 counts the order number indicating the number of times in which information is received for the product lane (Lane 2), referring to the existing information regarding the product lane (Lane 2) of the shelf plate SL131 stored in the product placement position table information. In the case of information which is received for the first time for the product lane, the processor 410 updates the product placement position table information stored in the memory unit 420 assuming that the product C has been placed at the first position of the second product lane (Lane 2) of the shelf plate SL131 of the shelf number #1. Each time the terminal device 400 receives the above information transmitted from the control unit 500 as a result of the reading of the product code information with the code scanner 550 by the store employee and the placement of the product on an arbitrary product lane of an arbitrary shelf plate SL131 of the product replenishment shelf SL130, the processor 410 of the terminal device 400 executes the above-described processing and updates the product placement position table information stored in the memory unit 420. In this manner, for each shelf plate SL131 of the product replenishment shelf SL130, the product placement position table information, which includes the types of respective products and the placement positions of these products, is managed in matrix-like data structure.

Next, in step S46, in the case where the placement operation of the products of the type and quantity designated by the product replenishment information onto the product replenishment shelf SL130 has been completed, or in the case where the placement operation is interrupted in the middle of the process, when the “Scan End” button B1 displayed on the display operation unit 430 of the terminal 400 is touched by the store employee, the processor 410 of the terminal 400 transmits the product placement position table information stored in the memory unit 420 at the time to the management apparatus 300 through the communication unit 440.

Further, in step S46, after the store employee moves the product replenishment shelf SL130 where the products have been placed as described above to a predetermined position in the store, when the store employee touches the “Start Replenishment Operation” button B2 displayed on the display operation unit 430 of the terminal 400, the processor 410 of the terminal 400 transmits command information to start the replenishment operation of replenishing a plurality of products from the product replenishment shelf Sl130 onto the stock shelf SL20 sequentially, to the management apparatus 300 through the communication unit 440. The predetermined position in the store where the product replenishment shelf SL130 is to be moved and positioned is, for example, a position adjacent to the other end of the rails R shown in FIG. 2, that is, a position adjacent to the end of the rails R opposite to the home position of the product replenishment robot 100.

Lastly, in step S47, after receiving the product placement position table information and the replenishment operation start command information as described above, the processor 310 of the management apparatus 300 transmits an instruction to the control device 150 of the product replenishment robot 100, for causing the product replenishment robot 100 to perform operation of sequentially replenishing a plurality of products from the product replenishment shelf SL130, positioned at a predetermined position in the store, onto the stock shelf SL20. Upon receiving the instruction, the control device 150 operates the product replenishment robot 100, and operation of moving the products on the product replenishment shelf SL130 onto the stock shelf SL20 is performed by the product replenishment robot 100.

Since the product placement position table information including the type and placement position of each product arranged on each shelf plate SL131 of the product replenishment shelf SL130 is transmitted from the management apparatus 300 to the control device 150 as described above, the control device 150 has information regarding which product is placed at what ordinal position (n-th position) of which product lane on which shelf plate SL131 of the product replenishment shelf SL130. Further, the control apparatus 150 has information regarding which product should be replenished into which lane of the stock shelf SL20. Therefore, the control device 150 repeatedly causes the product replenishment robot 100 to hold and take out a certain product from the product replenishment shelf SL130 and move the product to the corresponding lane on the stock shelf SL20, to replenish the products on the product replenishment shelf SL130 onto the stock shelf SL20.

It should be noted that the operation of replenishing the products from the product replenishment shelf SL130 to the stock shelf SL20 is the same as the operation described with reference to FIG. 9. Therefore, description thereof is omitted herein. Further, as with the first embodiment, also in the present embodiment, in the case of replenishing a product T from the product replenishment shelf SL130 to the stock shelf SL20, the drive mechanism of the stock shelf SL20 places the shelf plate SL21 of the stock shelf SL20 in a first posture in which the end on the front side is higher than the end on the back side, in accordance with a control signal transmitted from the communication unit of the control device 150 of the product replenishment robot 100 at the time of starting the operation of replenishing the product T from the product replenishment shelf SL130 to the stock shelf SL20. In this manner, it becomes possible to sequentially replenish the products onto the product row of the shelf plate SL21. Further, after the product replenishment operation from the product replenishment shelf SL130 to the stock shelf SL20 is completed, the drive mechanism of the stock shelf SL20 places the shelf plate SL21 of the stock shelf SL20 in a second posture in which the end on the front side is lower than the end on the back side, in accordance with a control signal transmitted from the communication unit of the control device 150 after completion of the replenishing operation. In this manner, it becomes possible for the product replenishment robot 100 to take out the product located at the frontmost position on the front side of the stock shelf SL20 and move the product to the product display shelf SL10 for replenishment.

As described above, in the present embodiment, even if the store employee places the product on an arbitrary product lane on an arbitrary shelf plate SL131 of the product replenishment shelf SL130, it becomes possible for the product replenishment robot 100 to replenish the product on the product replenishment shelf SL130 to the predetermined position of the stock shelf SL20. Therefore, it is possible to prevent malfunctions where products are replenished to the incorrect position on the stock shelf SL20 due to errors in the product placement position on the product replenishment shelf SL130. Further, since it is possible to place the product at an arbitrary position of the product replenishment shelf SL130, it becomes possible for the store employee to place the product on the product replenishment shelf SL130 without confirming the placement position. Thus, the burden and the time required for the store employee to perform operation of placing the product on the product replenishment shelf SL130 are reduced.

Further, it becomes unnecessary for the management apparatus 300 to generate the placement layout information beforehand, and it becomes possible to omit various processing steps based on the placement layout information.

### (Modification)

Next, a modification of the second embodiment will be described. The second embodiment has been described in connection with the operation example where, in the operation of placing products on the product replenishment shelf SL130, for each product, the store employee reads the code of the product taken out from a package box with the code scanner 550 and places the product on an arbitrary product lane of an arbitrary shelf plate SL131 of the product replenishment shelf SL130. The processor 501 of the control unit 500 associates the product code information read by the code reading process of the code scanner 550 with information indicating the product lane of the shelf plate SL131 where a weight change is detected by the weight sensor 540 as a result of placement of the product after the code reading process, and transmits the associated information from the communication unit 530 to the terminal device 400. In contrast, in the present embodiment, in the case of repeatedly placing products of the same type on the product replenishment shelf SL130, the operation of reading the product code with the code scanner 550 is performed only for the first product. In this manner, as long as products of the same type are subsequently repeatedly placed on the product replenishment shelf SL130, means for making it possible to omit the operation of causing the code scanner 550 to read the code for products of the same type is provided.

In the modification, in step S42 described above, after reading the code of the product taken out from a package box using the code scanner 550, the store employee may place two or more products of the same type consecutively on an arbitrary product lane of an arbitrary shelf plate SL131 of the product replenishment shelf SL130. Then, in step S43 described above, the processor 501 of the control unit 500 obtains the code information of a certain type of the product read by the code reading process of the code scanner 550 (for example, a certain product A having a capacity of 500 mL), and information regarding one or more product lanes and the placement order on the shelf plate SL131 where a weight change is detected by the weight sensor 540 as a result of placement of a plurality of products sequentially after the code reading process, and associates these items of information with each other to store the associated information at least temporarily in the memory unit 520. Then, when a code reading process of another type of product is performed by the code scanner 550 for placing the other type of product, the processor 501 transmits the above associated information stored in the memory unit 520 from the communication unit 530 to the terminal device 400.

As described above, according to the present embodiment, as long as the type of the product to be placed does not change, the store employee performs the code reading process using the code scanner 550 only once for the first product of a given type of products, and thereafter, even in the case where products of the same type are placed consecutively at arbitrary positions on the product replenishment shelf SL130, it is possible to obtain the product placement position table information for a plurality of these products. Therefore, it becomes possible to omit the operation of repeatedly reading the code of the same type of products using the code scanner 550.

It should be noted that, at the time of placing a product on a product lane of the shelf plate SL131 of the product replenishment shelf SL130 after the code of the product is read by the code scanner 550, there is a possibility that the product may topple over on the product lane or that a plurality of products may be placed on the product lane at the same time. In the former case, the weight change when the product is placed on the product lane, and the weight change when the product topples over, i.e., two weight changes may be detected by the weight sensor 540. In the latter case, only one weight change may be detected by the weight sensor 540. Therefore, in either case, there is a possibility that the number of products placed on the product replenishment shelf SL130 may not be correctly recognized.

In contrast, in this modification, as described above, each time the code scanner 550 performs a code reading process, the processor 501 transmits the numerical data of the weight of the products on each product lane, as measured by each weight sensor 540 installed in each product lane of each shelf plate SL131, from the communication unit 530 to the terminal device 400. The numerical data of the weight of the products indicates the increase in weight which has occurred between the previous scanning operation and the current scanning operation. Then, the processor 410 of the terminal device 400 may compare the product placement position table information, which may include the type and quantity of products obtained as placed on each product lane of each shelf plate SL131 after the code reading process, with information regarding the quantity of products (calculated quantity) actually placed on each product lane between the previous and current scanning operations, calculated by dividing the numerical data regarding the weight of products on each product lane by the weight per unit quantity of the product identified by the scanned code information (e.g., 500 g as the weight for product A having a capacity of 500 ml). If both do not match, the quantity of products calculated based on the numerical data of the weight increase on each product lane may be assumed correct, and assuming that the products are placed on the product lane, the quantity information of the products included in the product placement position table information may be updated.

By way of example, a case will be described where after performing the process of reading the code of the product A by the code scanner 550, when attempting to place the product A on the first product lane of the first shelf plate SL131, the product A topples over once on the first product lane, and then, the product A is picked up and placed again on the first product lane. In this case, since the weight sensor 540 installed on the first product lane of the first shelf plate SL131 detects two weight changes after the code reading process of the product A has been performed, the terminal device 400 obtains the product placement position table information assuming that two products A have been placed on the product lane. On the other hand, the numerical data of the weight increase of the products on the first product lane, as measured by the weight sensor 540 of the product lane (i.e., the data of the weight increase after the code reading of product A has been performed), is approximately 500 g, which corresponds to the weight of one product A, and this numerical value is transmitted to the terminal device 400. The processor 410 of the terminal device 400 compares the increase in the quantity of the product A on the first product lane, indicated as “2” in the product placement table information, with the quantity of products actually placed on each product lane between the previous and the current scanning operations (in effect, “1”), which is obtained by dividing the above weight increase of 500 g by 500 g as the weight of one product A. Since both do not match, as a result, the processor 410 updates the product placement table information assuming that only one product A which is the latter quantity has been placed on the first product lane of the first shelf plate SL131.

Further, by way of another example, a case will be described where after performing the process of reading the code of the product A by the code scanner 550, two products A are placed simultaneously on the first product lane of the first shelf plate SL131. In this case, since the weight sensor 540 installed on the first product lane of the first shelf plate SL131 detects a single weight change after performing the code reading process for the product A, the terminal device 400 obtains product placement table information assuming that one product A has been placed on the product lane. On the other hand, the numerical data of the weight increase on the first product lane measured by the weight sensor 540 of the product lane (i.e., the data of the weight increase after the code reading of the product A) corresponds to the value for two products A, which is approximately 1000 g, and the numerical data is transmitted to the terminal device 400. The processor 410 of the terminal device 400 compares the increase in the quantity of the product A on the first product lane, indicated as “1” in the above product placement table information, with the quantity of products actually placed on each product lane between the previous and current scanning operations (in effect, “2”), which is obtained by dividing the above weight increase of 1000 g by the weight of one product A (500 g per unit). Since both do not match, as a result, the processor 410 updates the product placement table information assuming that two products A which is the latter quantity have been placed on the first product lane of the first shelf plate SL131.

### [Third Embodiment]

Next, the third embodiment of the present disclosure will be described. In the first and second embodiments described above, the examples of performing the product replenishment operation from the product replenishment shelves SL30, SL130 to the stock shelf SL20 by the product replenishment robot 100 have been described. The present embodiment provides means which makes it possible for the product replenishment system to recognize the type and the placement position of the products placed on the stock shelf even in the case where the products are replenished on the stock shelf without using the product replenishment shelf.

The product replenishment system of the present embodiment may also have the same structure as the product replenishment robot 100, the control device 150, the management apparatus 300, and the terminal device 400 included in the product replenishment system 1 in the first embodiment. It should be noted that, in the present embodiment, the product image acquisition apparatus 200 in the first embodiment may be omitted, and the product replenishment shelves SL30, SL130 in the first and second embodiments may be omitted.

### <Structure of the Stock Shelf SL120>

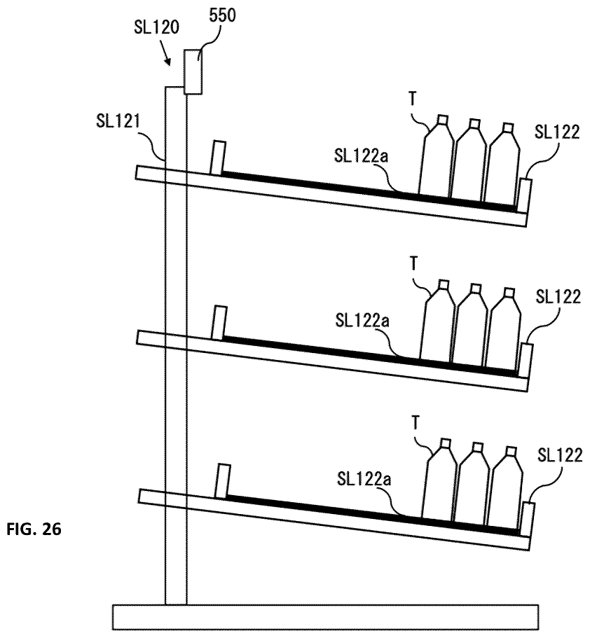

Next, structure of the stock shelf SL120 in the present embodiment will be described. The stock shelf SL120 in the present embodiment replaces the stock shelf SL20 in the first and second embodiments. FIG. 26 is a perspective view showing the overall structure of the stock shelf in the third embodiment. The stock shelf SL120 in the present embodiment basically has structure where the stock shelf SL20 described in the first embodiment has the control unit 500, the weight sensor 540, and the code scanner 550 of the product replenishment shelf SL130 described in the second embodiment. It should be noted that the stock shelf SL120 in the present embodiment may not necessarily have the function of changing the posture of each shelf plates SL122.

As shown in FIG. 26, the stock shelf SL120 in the present embodiment includes a frame structural body SL121 forming the overall framework, and a plurality of shelf plates SL122 provided for the frame structural body SL121. Further, a plurality of partition plates (not shown) for dividing the product lane are provided in each of the shelf plates SL122, and a plurality of floor plates SL122a having the weight sensors 540 (see FIG. 22), respectively, are provided individually for each product lane. The weight sensor 540 may adopt any known structure, such as a load cell type, a piezoelectric element type, or a capacitive type. Each of the weight sensors 540 is assigned with identification information corresponding to the product lane of each shelf plate SL122 where the weight sensor 540 is installed. As a result, it becomes possible to measure the weight of the products placed on each of the product lanes of the shelf plate SL122 where each weight sensor 540 is installed. It should be noted that the weight sensor 540 is one of the product placement sensors as means for detecting that the product has been placed on the product lane of the shelf plate SL122. As the product placement sensor, an optical sensor, etc. may be used instead of the weight sensor 540.

Further, the product replenishment shelf SL120 is provided with a code scanner 550 for scanning codes (including a barcode, a two-dimensional code, etc.) attached to the outer peripheral surface of the container of the product. For example, the code scanner 550 is configured to radiate a laser beam to the code attached to the product, and receive the reflected beam to read product information (including the type, the capacity, etc. of the product) indicated by the code. Further, the replenishment shelf SL120 includes the same control unit 500 as that described with reference to FIG. 22.

### <Operation Example>

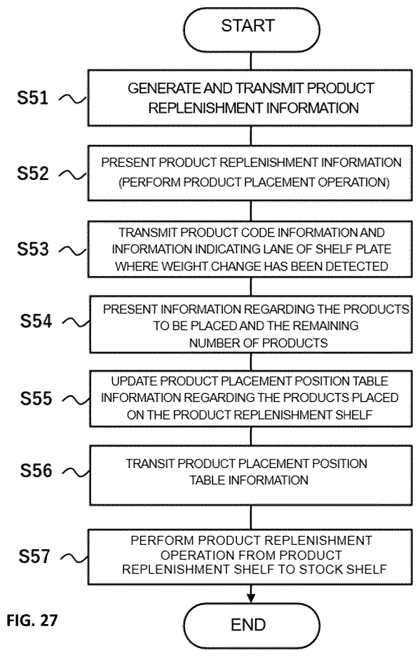

Next, an operation example of the product replenishment system 1 according to the embodiment will be described. FIG. 27 is a flow chart illustrating the operation example of the product replenishment system according to the third embodiment.

Firstly, in step S51, the processor 310 of the management apparatus 300 uses past sales data or a learned model for sales prediction stored in the memory unit 320 of the management apparatus 300 to predict a time schedule for replenishing each product on the display shelves SL10 and the stock shelves SL120 in each store, and based on this prediction, the processor 310 schedules the type and quantity of the product to be replenished to the stock shelf SL120 in the store as the target of product replenishment, and generates product replenishment information. The product replenishment information is related to the product to be replenished to the stock shelf SL120. The generated product replenishment information is transmitted from the communication unit 350 of the management apparatus 300 to the terminal device 400.

Next, in step S52, the terminal device 400 which has received the product replenishment information displays the product replenishment information to the display operation unit 430, and presents the product replenishment information to the store employee who uses the terminal device 400. The product replenishment information includes information regarding the type and the quantity of the products to be placed on the stock shelf SL120.

The store employee performs operation of placing the products of the types designated by the presented product replenishment information, in the designated number of products, on the stock shelf SL120. The operation of placing the products on the stock shelf SL120 includes placement of the products on an arbitrary product lane of an arbitrary shelf plate SL122 of the stock shelf SL120, after causing the code scanner 550 to read the product taken out from a package box by the operator.

In step S53, the processor 501 of the control unit 500 obtains product code information read by the code reading process performed by the code scanner 550, and information indicating a product lane of the shelf plate SL122 where a weight change is detected by the weight sensor 540 as a result of placement of the product after the code reading process, and associates these items of information with each other and transmits the associated information from the communication unit 530 to the terminal unit 400. This operation is repeatedly performed for each of the products. Further, each time the process of reading the code is performed by the code scanner 550, the processor 501 transmits numerical data of the total weight of products on each product lane, measured by each weight sensor installed on each product lane of each shelf plate SL122, from the communication unit 530 to the terminal device 400.

Next, in step S54, among the products included in the product replenishment information, for the product identified by the received code information, the processor 410 of the terminal device 400 which received the above information increments the “placed number” by 1 and decrements the “remaining number” by 1, and displays the quantity after these calculations on the display operation unit 430 and outputs the voice such as “the remaining replenishment quantity of the product A is X” from a speaker (not shown) of the terminal device 400. Further, as shown in FIG. 24, the processor 410 may display the character information such as “There are 23 products A left.” on the display operation unit 430. These processes are performed each time the terminal device 400 receives the code information. Further, for a product among the products included in the product replenishment information stored in the memory unit 420 for which a change has occurred in the “placed number” and the “remaining number”, the processor 410 updates these numbers to the changed values.

Next, in step S55, following the processing of step S44, or in parallel with the processing of step S54, the processor 410 of the terminal device 400 which has received the above information updates the product placement position table information, which is information regarding the type and position of one or more products placed on each shelf plate SL122 of the stock shelf SL120. In the terminal device 400 of the present embodiment, this product placement position table information is stored in the memory unit 420, and the product placement position table information is updated each time the terminal device 400 receives the above information from the control unit 500.

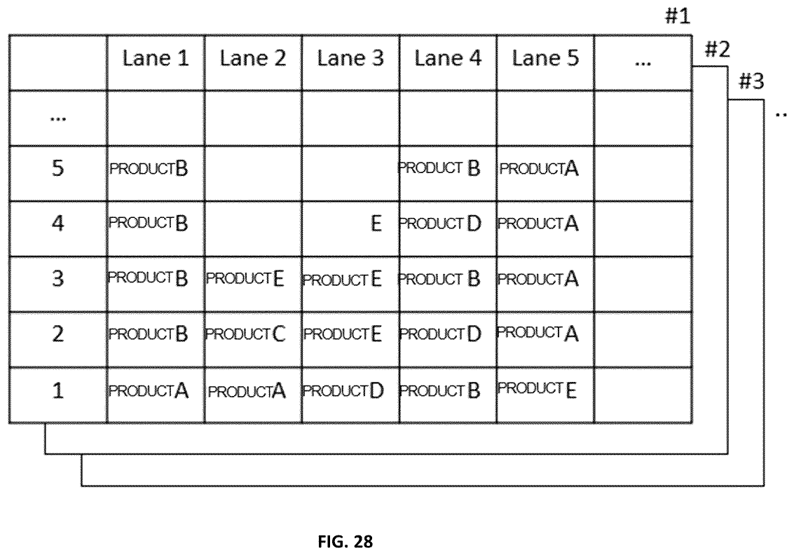

FIG. 28 is a view showing an example of the product placement position table information. The product placement position table information includes information about each shelf plate SL122 of the stock shelf SL122, about which type of product is positioned at which position. In FIG. 28, details of the product placement position table information regarding the shelf plate SL122 of the shelf number #1 are shown as an example.

When the processor 410 of the terminal device 400 receives code information of the product read in the code reading process by the code scanner 550, and information indicating the product lane of the shelf plate SL122 where a weight change is detected by the weight sensor 540 as a result of placement of the product after the code reading process, the processor 410 of the terminal device 400 counts the order in which information is received for the product lane of the shelf plate SL122, associates the shelf plate SL122, the product lane, and the determined order number with the product information indicated by the code information, and updates the product placement position table information stored in the memory unit 420. For each shelf plate SL122 of the stock shelf SL120, the product placement table information, which includes the type of each of the products and placement positions of the products, is managed in matrix-like data structure.

Next, in step S56, in the case where the placement operation of the products of the type and quantity designated by the product replenishment information onto the product replenishment shelf SL130 has been completed, or in the case where the placement operation is interrupted in the middle of the process, when the “Scan End” button B1 (see FIG. 24) displayed on the display operation unit 430 of the terminal 400 is touched by the store employee, the processor 410 of the terminal 400 transmits the product placement position table information stored in the memory unit 420 at the time to the management apparatus 300 through the communication unit 440.

Lastly, in step S57, when the store employee touches the “Start Replenishment” button B2 (see FIG. 24) displayed on the display operation unit 430 of the terminal 400, the processor 410 of the terminal 400 transmits command information to start the replenishment operation of replenishing a plurality of products from the stock shelf SL120 onto the display shelf SL10 sequentially, to the management apparatus 300 through the communication unit 440. After receiving the product placement position table information and the replenishment operation start command information as described above, the processor 310 of the management apparatus 300 transmits, to the control device 150 of the product replenishment robot 100, an instruction causing the product replenishment robot 100 to sequentially replenish a plurality of products from the stock shelf SL122, located at a predetermined position in the store, onto the product display shelf SL10. Upon receiving the instruction, the control device 150 operates the product replenishment robot 100 to perform the operation of moving products from the stock shelf SL120 onto the product display shelf SL10.

Since the product placement position table information, which includes the type and placement position of each product arranged on each shelf plate SL122 of the stock shelf SL120, is transmitted from the management apparatus 300 to the control device 150 as described above, the control device 150 has information regarding which product is placed at what ordinal position (n-th position) of which product lane on which shelf plate SL122 of the stock shelf SL120. Further, the control device 150 has information regarding which product should be replenished into which lane of the product display shelf SL10. Therefore, the control device 150 repeatedly causes the product replenishment robot 100 to hold and take out a certain product from the stock shelf SL120 and move the product to the corresponding lane on the product display shelf SL10, to replenish the products from the stock shelf SL120 onto the product display shelf SL10. It should be noted that the replenishment operation of the products from the stock shelf SL120 to the product display shelf SL10 by the product replenishment robot 100 is the same as the operation described with reference to FIG. 9, and description thereof is omitted herein.

It should be noted that as in the case of the stock shelf SL20 according to the first embodiment, each shelf plate SL122 of the stock shelf SL120 is configured to be switchable between the first posture where the end on the front side of the shelf plate SL122 is higher than the end on the back side of the shelf plate SL122 and the second posture where the end of the front side of the shelf plate SL122 is lower than the end of the back side of the shelf plate SL122, at the time of replenishing the product from the stock shelf SL120 to the product display shelf SL10, the drive mechanism of the stock shelf SL120 places each shelf plate SL122 of the stock shelf Sl120 in the second posture where the end of the front side is lower than the end on the back side, in accordance with the control signal transmitted from the communication unit of the control device 150 to the control unit 500 when operation of replenishing products from the stock shelf SL120 to the product display shelf SL10 is started. In this manner, it becomes possible for the product replenishment robot 100 to take out the products on the shelf plate SL122 sequentially. Further, after the product replenishing operation from the stock shelf SL120 to the product display shelf SL10 is completed by the product replenishment robot 100, the drive mechanism of the stock shelf SL120 places each shelf plate SL122 of the stock shelf SL120 in the first posture where the end on the front side is higher than the end on the back side, in accordance with the control signal transmitted from the communication unit of the control device 150 to the control unit after the replenishment operation. In this manner, it becomes possible for the store employee to place the products from the front side of the stock shelf SL120.

As described above, in the present embodiment, even in the case where the store employee places the products on an arbitrary product lane on an arbitrary shelf plate SL122 of the stock shelf SL120, it becomes possible for the product replenishment robot 100 to replenish the products on the stock shelf SL120 at the predetermined position of the product display shelf SL10. Therefore, it is possible to prevent malfunctions where products are replenished to the incorrect position on the product display shelf SL10 due to errors in the product placement positions on the stock shelf SL120. Further, since the product can be placed at the arbitrary position on the stock shelf SL120, it becomes possible for the store employee to place the product on the stock shelf SL120 without confirming the placement position. Thus, the burden and the time required for the store employee to perform the operation of placing the products on the stock shelf SL120 are reduced.

It should be noted that, also in the present embodiment, as with the modification of the second embodiment, means which makes it possible to omit the operation of reading the code for the same type of the products by the code scanner 550 and/or means for recognizing the placement quantity even in the case where the product is toppled over on the product lane or a plurality of products are placed on the product lane at the same time may be provided.

While the present disclosure has been described though embodiments of the invention, the embodiments are not intended to limit the scope of the invention as claimed. Further, any form of combination of the features described in the embodiments of the present disclosure may also be included in the technical scope of the invention. Furthermore, it is also apparent to those skilled in the art that various modifications or improvements can be made to the embodiments described above.

1. A management apparatus configured to manage product replenishment by a product replenishment robot, the product replenishment robot being configured to hold a product placed on a stock shelf and move the product to a product display shelf,
the management apparatus comprising a control unit and a memory unit,
wherein the memory unit is configured to store sales data including the past sales quantity and the sales date and time of the product or a learned model generated by performing machine learning on a learning device using the sales data; and
the control unit is configured to perform generating product replenishment information regarding the product to be replenished on the stock shelf, based on the sales data or the learned model.

2. The management apparatus according to claim 1, wherein the management apparatus is configured to be communicatively connected to a terminal device used by an operator; and
the control unit is configured to further perform transmitting the product replenishment information to the terminal device and displaying the product replenishment information on the terminal device.

3. The management apparatus according to claim 2, wherein the product replenishment robot is configured to further perform operation of holding the product placed on the product replenishment shelf and moving the product to the stock shelf;
the product replenishment information includes placement layout information for placing the product to be replenished to the stock shelf in each area on the product replenishment shelf; and
the control unit is configured to further perform displaying, on the terminal device, the placement layout information included in the product replenishment information selected by an input operation by the operator on the terminal device.

4. The management apparatus according to claim 3, wherein the terminal device comprises a camera configured to capture an image to obtain image data;
identification information for identifying each of the product replenishment shelf is attached to the product replenishment shelf; and
the control unit is configured to perform displaying the placement layout information on the terminal device in the case where the identification information of the product replenishment shelf captured by the camera of the terminal device matches the identification information of the product replenishment shelf associated with the placement layout information included in the selected product replenishment information.

5. The management apparatus according to claim 4, wherein the placement layout information displayed on the terminal device includes the type and the number of products to be placed in each area on the product replenishment shelf.

6. The management apparatus according to claim 5, wherein the number of each of the products included in the placement layout information can be changed by an input operation by the operator on the terminal device; and
the control unit is configured to further perform updating the placement layout information to reflect the number of the products changed by the input operation by the operator on the terminal device.

7. The management apparatus according to claim 3, wherein the control unit is configured to cause the product replenishment robot to perform operation of moving the product placed on the product replenishment shelf in accordance with the layout information, to the stock shelf, when the control unit receives completion confirmation information indicating that the product replenishment shelf where the product is placed has been placed at a predetermined position in accordance with the placement layout information, from the terminal device.

8. The management apparatus according to claim 7, wherein the terminal device comprises a camera configured to capture an image to obtain image data;
identification information for identifying each of the product replenishment shelf is attached to the product replenishment shelf; and
the control unit is configured to cause the product replenishment robot to perform operation of moving the product to the stock shelf in the case where the identification information of the product replenishment shelf captured by the camera of the terminal device matches the identification information of the product replenishment shelf associated with the placement layout information included in the selected product replenishment information.

9. The management apparatus according to claim 7, wherein the control unit is configured to cause the product replenishment robot to perform operation of moving the product from the stock shelf to the product display shelf when the control unit receives removal confirmation information indicating that the product replenishment shelf has been removed from the predetermined position after completion of replenishment of the product from the product replenishment shelf to the stock shelf.

10. The management apparatus according to claim 7, wherein the product replenishment robot comprises a product identification apparatus configured to identify the type of the product held by the product replenishment robot; and
the product replenishment robot is configured to identify the type of at least one of the products placed on at least one of the areas of the product replenishment shelf by the product identification apparatus.

11. The management apparatus according to claim 3, wherein the stock shelf comprises one or a plurality of shelf plates;
the shelf plate is configured to be switchable between a first posture in which an end on the front side of the shelf plate, which faces the product display shelf arranged to face the stock shelf, is higher than an end on the back side of the shelf plate opposite to the front side of the shelf plate and a second posture in which the end on the front side is lower than the end on the back side; and
while operation of moving the product placed on the product replenishment shelf to the stock shelf is performed by the product replenishment robot, the shelf plate is placed in the first posture, and while operation of moving the product placed on the stock shelf to the product display shelf is performed by the product replenishment robot, the shelf plate is placed in the second posture.

12. The management apparatus according to claim 3, wherein the stock shelf comprises:
one or a plurality of shelf plates each having a plurality of product lanes, wherein a product placement sensor configured to detect that the product has been placed is provided in each of the product lanes of each of the shelf plates;
a code reading unit configured to read code information attached to the product; and
a control unit configured to control the product placement sensor and the code reading unit, and connected communicatively to the management apparatus and the terminal device, and
wherein the control unit is configured to associate the code information read by the code reading unit with the position information on the product lane of the shelf plate of the stock shelf where the product is placed after the code information is read.

13. The management apparatus according to claim 12, wherein the control unit is configured to further transmit the associated code information and the position information to the terminal device;
the terminal device is configured to generate product placement position table information by associating, for each of a plurality of products identified by the code information, the type of the product with the position information of the product on the stock shelf, and to transmit the product placement position table information to the management apparatus; and
the control unit of the management apparatus is configured to cause the product replenishment robot to perform operation of moving the product placed on the stock shelf in accordance with the product placement position table information, to the product display shelf.

14. The management apparatus according to claim 12, wherein the control unit is configured to associate single code information read in a single code reading operation by the code reading unit with the position information of at least one of the products placed on the product lane of the shelf plate of the stock shelf after the code information is read.

15. The management apparatus according to claim 13, wherein the product placement sensor is a weight sensor configured to detect the weight change in the product lane and the weight of the product placed on the product lane;
the control unit is configured to further transmit information regarding the weight increase of the product placed on each of the product lanes between two code reading operations by the code reading unit; and
the terminal device is configured to compare information regarding the type and the placement quantity of the product placed on each of the product lanes indicated by the product placement position table information with a calculated quantity obtained by dividing the weight increase of each of the product lanes by the weight per unit of the associated product, and to update the placement quantity of the product included in the product placement position table information to the calculated quantity, in the case where the placement quantity and the calculated quantity do not match.

16. The management apparatus according to claim 3, wherein the product replenishment robot is configured to further perform operation of holding the product placed on the product replenishment shelf and moving the product to the stock shelf,
the product replenishment shelf comprises:
one or a plurality of shelf plates each having a plurality of product lanes, wherein a product placement sensor configured to detect that the product has been placed is provided in each of the one or the plurality of shelf plates;
a code reading unit configured to read code information attached to the product; and
a control unit configured to control the product placement sensor and the code reading unit, and connected communicatively to the management apparatus and the terminal device,
wherein the control unit is configured to associate the code information read by the code reading unit with the position information on the product lane of the shelf plate of the product replenishment shelf on which the product is placed after the code information is read.

17. The management apparatus according to claim 16, wherein the control unit is configured to further transmit the associated code information and the position information to the terminal device;
the terminal device is configured to generate, for a plurality of the products identified by the code information, product placement position table information by associating the type of each product with the position information of the product on the product replenishment shelf, and to transmit the product placement position table information to the management apparatus; and
the control unit of the management apparatus is configured to cause the product replenishment robot to perform operation of moving the product placed on the product replenishment shelf in accordance with the product placement position table information, to the stock shelf.

18. The management apparatus according to claim 16, wherein the control unit is configured to associate single code information read in a single code reading operation by the code reading unit with the position information of at least one of the products placed on the product lane of the shelf plate of the product replenishment shelf after the code information is read.

19. The management apparatus according to claim 17, wherein the product placement sensor is a weight sensor configured to detect the weight change on the product lane and the total weight of the products placed on the product lane;
the control unit is configured to further transmit the total weight information regarding the total weight of the products placed on each of the product lanes; and
the terminal device is configured to compare information regarding the type and the placement quantity of the product placed on each of the product lanes indicated by the product placement position table information with a calculated quantity obtained by dividing the total weight of each of the product lanes by the weight per unit of the associated product, and to update the placement quantity of the product included in the product placement position table information to the calculated quantity, in the case where the placement quantity and the calculated quantity do not match.

20. A product replenishment system comprising:
a product replenishment robot configured to perform operation of holding and moving a product; and
the management apparatus according to claim 1.
